(19) United States
(12) Patent Application Publication
(10) Pub. No.: US 2024/0425948 A1
(43) Pub. Date: Dec. 26, 2024

(54) EFFICIENT RECYCLING OF E-WASTE BY ENERGY LANDSCAPE INVERSION

(71) Applicant: North Carolina State University, Raleigh, NC (US)

(72) Inventors: Martin Thuo, Raleigh, NC (US); Alana Pauls, Raleigh, NC (US); Dhanush Jamadgni, Raleigh, NC (US)

(21) Appl. No.: 18/752,936

(22) Filed: Jun. 25, 2024

Related U.S. Application Data
(60) Provisional application No. 63/523,156, filed on Jun. 26, 2023.

(51) Int. Cl. C22B 59/00; C22B 3/02; C22B 3/20; C22B 3/32; C22B 4/04; C22B 7/00; C22B 11/00; C22B 34/24; C22B 58/00

(52) U.S. Cl. CPC C22B 59/00; C22B 3/02; C22B 3/20; C22B 3/32; C22B 4/04; C22B 7/006; C22B 11/04; C22B 34/24; C22B 58/00

(57) ABSTRACT

The present invention provides methods for recovering metals, including rare earth metals, from mixed metals. An example is the recovery of metals from electronic waste. The method of separation is based on the inversion and/or lowering of the thermodynamic energy barrier by using one or more stressors applied at appropriate ratios to create lower energy points in the thermodynamic energy landscape of the mixed metals. Example stressors include a) a chemical stress, b) a mechanical stress, c) a thermal stress, d) and electromagnetic radiation and/or light stress, an interfacial stress, and/or a magnetic flux gradient stress.

### CROSS-REFERENCE

This application claims the benefit of Provisional Application No. 63/523,156, filed on Jun. 26, 2023, which is incorporated herein by reference in its entirety.

This invention was made with government support under grant number HR0011-22-9-0088 awarded by the Defense Advanced Research Projects Agency. The government has certain rights in the invention.

### FIELD OF THE INVENTION

The present invention relates generally to a recovery of metals from a mixed-metals stream. More specifically it relates to recovery of metals, including rare earth metals, from a mixed-metals stream such as from electronic waste.

### BACKGROUND OF THE INVENTION

Rare earth metals are frequently used in electric, luminescent, and catalytic components. For example, praseodymium, neodymium, and dysprosium are frequently used in wind turbines, cordless power tools, hybrid vehicles, magnets, and defense equipment, and europium is frequently used in light bulbs, LCD screens, and plasma screens.

Obtaining virgin rare earth metals is challenging for several reasons. The processing is typically messy due to ores that naturally include radioactive material (Uranium and thorium) with the rare earth elements of interest. This results in waste and environmental damage. Furthermore, as of 2019, China contains approximately ⅓ of the world's reserves of rare earths which can cause global supply-chain issues.

Recycling and/or repurposing rare earth metals from the products containing them is critical for the sustainability of rare earth metals. Most current recycling methods use chemical leaching or smelting, each of which produces its own waste. There is a need for more energy efficient methods for recovering and repurposing rare earth metals.

### BRIEF SUMMARY OF THE INVENTION

According to an embodiment of the present invention, a method of separation of metals is presented. The method of separation is based on inversion and/or lowering of the thermodynamic energy barrier by using one or more stressors applied at appropriate ratios to create lower energy points in the thermodynamic energy landscape. The method comprises using the one or more stressors to separate at least two reclaimable metals from a mixed-metal feed. The one or more stressors is selected from the group consisting of a) a chemical stress, wherein the chemical stress is selected from the group consisting of an oxidant, an acid, a base, a ligand or chelate, a reactant, a speciating agent, a reducing agent, a nucleophile, and/or an electrophile; b) a mechanical stress, wherein the mechanical stress comprises principle stresses, deviatoric stresses, point forces, and/or body forces; c) a thermal stress; d) an electromagnetic radiation and/or light stress; e) an interfacial stress; and/or f) a magnetic flux gradient stress.

According to another embodiment of the present invention, a method of separation of metals is presented. The method of separation is based on inversion and/or lowering of the thermodynamic energy barrier by using one or more stressors applied at appropriate ratios to create lower energy points in the thermodynamic energy landscape. The method comprises using the one or more stressors to separate at least two reclaimable metals from a mixed-metal feed. The one or more stressors is selected from the group consisting of a) a chemical stress, wherein the chemical stress is selected from the group consisting of an oxidant, an acid, a base, a ligand or chelate, a reactant, a speciating agent, a reducing agent, a nucleophile, and/or an electrophile; b) a mechanical stress, wherein the mechanical stress comprises principle stresses, deviatoric stresses, point forces, and/or body forces; c) a thermal stress; d) an electromagnetic radiation and/or light stress; e) an interfacial stress; and/or f) a magnetic flux gradient stress. One of the one or more stressors is a first asymmetric stress, and wherein the first asymmetric stress is selected from the group consisting of the chemical stress, the mechanical stress, or the thermal stress.

According to yet another embodiment of the present invention, a process of separating a stream of electronic waste (e-waste) metals is presented. The e-waste metals comprise at least two reclaimable metals comprising a first reclaimable metal and a second reclaimable metal. The process comprises a) performing a first extraction/precipitation/separation step of the e-waste metals to produce a productₓ and a (residual e-waste metals)ₓ, wherein X=1; b) performing a next extraction/precipitation/separation step of the (residual e-waste metals)ₓ to produce a productₓ₊₁ and a (residual e-waste metals)ₓ₊₁, and c) incrementing x by 1, and repeating step b) until an amount of the at least two reclaimable metals in the (residual e-waste metals)ₓ is less than 5 wt. % of an amount of the at least two reclaimable metals in the e-waste metals. For each of the step a) and the step b) extractions/precipitation/separation steps, a variation is selected from the group consisting of a solvent, a solvent pH, an extraction temperature, an electromagnetic radiation stress, and/or a mechanical stress applied to the e-waste metals and/or (residual e-waste metals)ₓ.

According to yet another embodiment of the present invention, a method of separation of metals, and purifying a target metal is presented. The method of purification is based on inversion and/or lowering of the thermodynamic energy barrier by using one or more stressors applied at appropriate ratios to create lower energy points in the thermodynamic energy landscape. The method comprises 1) using the one or more stressors on a mixed-metal feed to produce a mixed-metal residue and an intermediate product, wherein the intermediate product comprises target metal particles and at least one other metal particles, wherein the target metal particle comprise a higher weight percent of the target metal than in the mixed-metal feed, and 2) producing a purified product. The purified product comprises a higher weight percent of the target metal than the weight percent of the target metal in the intermediate product. The purified product is produced by using the one or more stressors to separate the target metal particles from the at least one other metal particles by exploiting differences in at least one of the properties of the target metal and/or a particles with a higher concentration of the target metal than the intermediate product. The properties are selected from the group consisting of a) size, b) shape, c) density, d) magnetism, and/or e) solubility/extractability. The one or more stressors is selected from the group consisting of a) a chemical stress, wherein the chemical stress is selected from the group consisting of an oxidant, an acid, a base, a ligand or chelate, a reactant, a speciating agent, a reducing agent, a nucleophile, and/or an electrophile; b) a mechanical stress, wherein the mechanical stress comprises principle stresses, deviatoric stresses, point forces, and/or body forces; c) a thermal stress; d) an electromagnetic radiation and/or light stress; e) an interfacial stress; and/or f) a magnetic flux gradient stress.

According to yet another embodiment of the present invention, a method of mixing metals is presented. The method of mixing is based on inversion and/or lowering of the thermodynamic energy barrier by using one or more stressors applied at appropriate ratios to create lower energy points in the thermodynamic energy landscape. The method comprises using the one or more stressors to mix at least two metals into a mixed-metal product. The one or more stressors is selected from the group consisting of a) a chemical stress, wherein the chemical stress is selected from the group consisting of an oxidant, an acid, a base, a ligand or chelate, a reactant, a speciating agent, a reducing agent, a nucleophile, and/or an electrophile; b) a mechanical stress, wherein the mechanical stress comprises principle stresses, deviatoric stresses, point forces, and/or body forces; c) a thermal stress; d) an electromagnetic radiation and/or light stress; e) an interfacial stress; and/or f) a magnetic flux gradient stress.

According to yet another embodiment of the present invention, a method of separating a stream of electronic waste (e-waste) metals is presented. The e-waste metals comprise europium, praseodymium, neodymium, dysprosium, gallium, indium, iron, and tantalum. By sequential extraction, varying a chemical stress, varying a mechanical stress, varying a thermal stress, varying an electromagnetic radiation and/or light stress, varying an interfacial stress, and/or varying a magnetic flux gradient stress applied to the e-waste metals and solvent for each of the sequential extractions to form a first residual metal and unrefined product streams. Alternatively, by sequential extractions, varying a solvent, varying a pH of the solvent, and varying an extraction temperature, and/or varying a mechanical stress applied to the e-waste metals and solvent for each of the sequential extractions to form a first residual metal and unrefined product streams. Depending upon the variations, different sets of unrefined product streams can be produced. The sets of unrefined product streams include a) a first set of the unrefined product streams comprising 1) a europium stream, 2) a praseodymium stream, 3) a neodymium stream, 4) a dysprosium stream. 5) an iron stream, and 6) a gallium and indium stream; b) a second set of the unrefined product streams comprising 1) a europium stream, 2) a praseodymium and neodymium stream, 3) a dysprosium and iron stream, and 4) a gallium and indium stream; c) a third set of the unrefined product streams comprises 1) a europium stream, 2) a praseodymium, neodymium, dysprosium, and iron stream, and 3) a gallium and indium stream; a fourth set of the unrefined product stream comprises 1) a europium stream, 2) a praseodymium, neodymium, dysprosium, iron, gallium, and indium stream; a fifth set of the unrefined product stream comprises 1) a europium, praseodymium, neodymium, dysprosium, and iron stream, and 2) a gallium and indium stream; or a sixth set of the unrefined product streams comprises 1) rare earth elements, iron, gallium, and indium stream.

According to yet another embodiment, a system for separation of a mixed-metal feed is presented. The separation of the mixed-metal feed is based on inversion and/or lowering of the thermodynamic energy barrier by using one or more stressors applied at appropriate ratios to create lower energy points in the thermodynamic energy landscape. The system comprises a) a chamber, b) at least one closable opening, c) a variable temperature device capable of supplying the thermal stresses, and d) a mechanical device capable of supplying the mechanical stresses. The chamber is capable of enclosing i) a solution comprising the mixed-metal feed and ii) at least a first asymmetric stress and a second asymmetric stress. The first asymmetric stress and a second asymmetric stress are selected from the group consisting of 1) a chemical stress, wherein the chemical stress is selected from the group consisting of an oxidant, an acid, a base, a ligand or chelate, a reactant, a speciating agent, a reducing agent, a nucleophile, and/or an electrophile; 2) a mechanical stress, wherein the mechanical stress comprises principle stresses, deviatoric stresses, point forces, and/or body forces; of 3) a thermal stress. The at least one closable opening is capable of providing a pathway for the mixed-metal feed, the chemical stress and any separated metals to enter and leave the chamber. A content of the chamber comprises the mixed-metal feed, any separated metals, and the solution. The thermal stress and the mechanical stress are applied to the content of the chamber.

According to yet another embodiment, a system for separation of a mixed-metal feed is presented. The separation of the mixed-metal feed is based on inversion and/or lowering of the thermodynamic energy barrier by using one or more stressors applied at appropriate ratios to create lower energy points in the thermodynamic energy landscape. The system comprises a) an extractor capable of containing a solution comprising the mixed-metal feed, wherein the extractor comprises a closeable hollow horizontal cylinder; b) a rotor placeable in the extractor with a proximal end outside of the extractor and a distal end with attachments within the extractor, wherein the rotor and attachments are capable of providing mechanical stress to the solution when the rotor turns; c) a motor connectable to the proximal end of a rotor, wherein the motor is capable of turning the rotor; d) a hole at the end of the extractor when the extractor is closed, through which the proximal end of the rotor transitions from outside the extractor to inside the extractor, wherein the hole is located below the midpoint of the cylinder; f) a heat source in the top half of the extractor, wherein the heat source is capable of applying a thermal stress to the solution. The system is capable of producing asymmetrical stresses on the solution.

According to yet another embodiment of the present invention a process of separating rare-earth metals is presented. The process comprises a) applying a magnetic force in a section of a curved pipe with the largest degree of curvature; b) feeding a first liquid stream comprising at least two mixed-rear-earth particles to the curved pipe. The first mixed-rare-earth particles comprise a first rare-earth metal and the second mixed-rare-earth particles comprise a second rare-earth metal; c) stratifying the first mixed-rare-earth particle from the second mixed-earth particle along an inside diameter of the pipe; and d) collecting two separate outlet streams. The first outlet stream comprises a majority of the first mixed-rare-earth particles and the second outlet stream comprises a majority of the second mixed-rare-earth particles.

### BRIEF DESCRIPTION OF THE DRAWINGS

The present invention is illustrated and described herein with reference to the various drawings, in which like reference numbers denote like method steps and/or system components, respectively, and in which:

FIG. 1 is a flowsheet of a non-limiting embodiment of separation process paths for separating out key metals from an electronic waste;

FIG. 2 is a set of Scanning Electron Microscope (SEM) images of europium and several europium acids in solvents of water, methanol, or ethanol;

FIG. 3a is a graph of magnetization versus temperature and FIG. 3b is a graph of magnetization versus magnetic field, each for samarium (III) acetate, (b) europium (III) acetate, and (c) gadolinium acetate of Examples 26(a)-26 (c), and Examples 27(a)-27 (c), respectively;

FIG. 4 is a graph of magnetization versus temperature for the europium (III) acetate of Example 28;

FIG. 5a is a 3D graph of magnetization versus temperature and FIG. 5b is a 3D graph of magnetization versus magnetic field for europium and europium acids with acids of different chain lengths of Examples 29(a)-29 (f) and Examples 30(a)-30 (f), respectively;

FIG. 6a is a graph of magnetization versus temperature and FIG. 6b is a graph of magnetization versus magnetic field for Europium (III) acetate, with no treatment, held under argon for two hours at either 573 K or 1073 K, of Examples 31(a)-31 (c) and Examples 32(a)-32 (c), respectively;

FIG. 7a is a graph of magnetization versus temperature and FIG. 7b is a graph of magnetization versus magnetic field for Europium (III) acetate, with no treatment, held under argon for two hours at either 573 K or 1073 K, of Examples 33(a)-33 (c) and Examples 34(a)-34 (c), respectively;

FIG. 8 is a schematic diagram of the medium-scale equipment used in Examples 35-41;

FIGS. 9(a)-9(d) are images characterizing the Magnet used in Examples 35-41 and Example 42, specifically FIG. 9(a) is a Scanning Electron Microscope (SEM) image, FIG. 9(b) is an Energy Dispersive Spectroscopy (EDS) image of iron, FIG. 9(c) is an EDS image of Nd, and FIG. 9(d) is an EDS of Pr;

FIG. 10 is a schematic of the large-scale experimental equipment for Example 42;

FIGS. 11(a)-(c) are schematics of a cut away view of the extractor showing the asymmetric stresses imparted on the extractor content with a heater in the upper section of the extractor and an offset rotor;

FIGS. 12(a)-(d) are characterizations of the extracted metals in Example 42, specifically (a) is a Scanning Electron Microscope (SEM) image, (b) is the individual EDS images for iron, (c) of neodymium, and (d) praseodymium;

FIGS. 13(a)-(d) are characterizations of the extracted metals in Example 42, specifically (a) is a Scanning Electron Microscope (SEM) image, (b) is the individual EDS images for iron, (c) of neodymium, and (d) praseodymium;

FIGS. 14(a)-(d) are characterizations of the extracted metals in Example 42, specifically (a) is a Scanning Electron Microscope (SEM) image, (b) is the individual EDS images for iron, (c) of neodymium, and (d) praseodymium;

FIGS. 15(a)-(d) are characterizations of the extracted metals in Example 42, specifically (a) is a Scanning Electron Microscope (SEM) image, (b) is the individual EDS images for iron, (c) of neodymium, and (d) praseodymium;

FIGS. 16(a)-(d) are characterizations of the extracted metals in Example 42, specifically (a) is a Scanning Electron Microscope (SEM) image, (b) is the individual EDS images for iron, (c) of neodymium, and (d) praseodymium;

FIGS. 17(a)-(c) are characterizations of the refined Nd from Example 42, specifically (a) is a Scanning Electron Microscope (SEM) image, (b) is the individual EDS images for iron, and (c) of neodymium;

FIGS. 18(a)-(c) are graphs of the elemental composition of the extract from Example 42 showing the weight percent of (a) iron, (b) neodymium, and (c) oxygen;

FIG. 19 is a schematic of a non-limiting embodiment of separation of metal particles in a curved pipe with a magnet.

### DETAILED DESCRIPTION OF THE INVENTION

According to an embodiment of the present invention, a method of separation of metals is presented. The method of separation is based on inversion and/or lowering of the thermodynamic energy barrier by using one or more stressors applied at appropriate ratios to create lower energy points in the thermodynamic energy landscape. The method comprises using the one or more stressors to separate at least two reclaimable metals from a mixed-metal feed. The one or more stressors is selected from the group consisting of a) a chemical stress, wherein the chemical stress is selected from the group consisting of an oxidant, an acid, a base, a ligand or chelate, a reactant, a speciating agent, a reducing agent, a nucleophile, and/or an electrophile; b) a mechanical stress, wherein the mechanical stress comprises principle stresses, deviatoric stresses, point forces, and/or body forces; c) a thermal stress; d) an electromagnetic radiation and/or light stress; e) an interfacial stress; and/or f) a magnetic flux gradient stress.

The present invention may be understood more readily by reference to the following detailed description of the invention taken in connection with the accompanying drawing figures, which form a part of this disclosure. It is to be understood that this invention is not limited to the specific devices, methods, conditions, or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

It is to be understood that the mention of one or more method steps does not preclude the presence of additional method steps before or after the combined recited steps or intervening method steps between those steps expressly identified. Moreover, the lettering of method steps or ingredients is a conventional means for identifying discrete activities or ingredients and the recited lettering can be arranged in any sequence, unless otherwise indicated.

As used herein, the term “and/or”, when used in a list of two or more items, means that any one of the listed items can be employed by itself, or any combination or two or more of the listed items can be employed. For example, if a composition is described as containing compounds A, B, “and/or” C, the composition may contain A alone; B alone; C alone; A and B in combination; A and C in combination; B and C in combination; or A, B, and C in combination.

As used herein, the terms “mixed-metal stream” and “mixed metal feed” are used interchangeably an refer to a substance that comprises multiple metals and is the starting material of the claimed method. As used herein, the term “reclaimable metals” refers to metals that are intended to be recovered from a “mixed-metals stream” such as an electronic waste stream/feed.

As used herein, the term “metal particle” refers to the precipitated metal post extraction. These “metal particles” are typically smaller than the size of the mixed-metal pieces that are being extracted.

As used herein, the term “extraction/precipitation/separation step” refers to the extraction of one or more metals from a mixed-metals stream into a solvent along with the precipitation of one or more different metal particles which is followed by the separation of the extracted metal particles from the remnant mixed-metals stream. Examples of the “extraction/precipitation/separation step” are abundant in the Examples Section.

As used herein, the term “stressor” or “stress” is the mechanism by which components move from a stable state to a different stable state of a semi-stable state. “Stressors” can be, for example a chemical stress, a mechanical stress, a thermal stress an electromagnetic stress, an interfacial stress, a magnetic flux gradient stress, etc. The term “asymmetric stressor” or “asymmetric stress” is a stress that is stronger near the source of the “asymmetric stressor” and decreases as the distance from the source increases. As used herein, the term “vector” is used to represent the direction of the gradient of the “asymmetric stress.”

The present invention provides a method of separation based on inversion and/or lowering of the thermodynamic energy barrier by using one or mor stressors applied at appropriate ratios to create lower energy points in the thermodynamic energy landscape. Non-limiting examples of stressors are a chemical stress, a mechanical stress, a thermal stress, an electromagnetic radiation and/or light stress, an interfacial stress, and/or a magnetic flux gradient stress. For example, in an electronic waste (e-waste) comprising gallium, indium, praseodymium, neodymium, europium, and dysprosium, changes in pH can be used to selectively separate the elements. Low pH of around 2 favors extraction of gallium and indium. High pH about 12 favors extraction of neodymium.

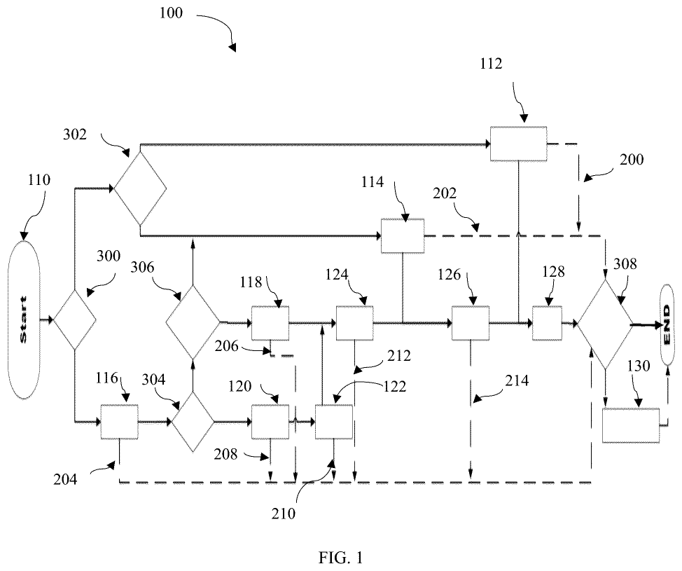

Depending upon such factors as the composition of the e-waste stream and the desired metal product compositions, various separation process paths can be chosen in the recovery process for the e-waste. FIG. 1 is a flowsheet of a non-limiting embodiment of separation process paths 100 for separating out key metals from electronic waste (e-waste) 110. As depicted in FIG. 1, the e-waste 110 contains the metals europium, praseodymium, neodymium, dysprosium, gallium, indium, iron, and tantalum. The e-waste 110 may be pretreated with an acid and a solvent, for example acetic acid and water to produce the corresponding acetate, e.g. Europium (III) Acetate (not shown). The first decision point 300 is whether to start with a coextraction of multiple metals. If yes to decision point 300, then the next decision point 302 is whether to coextract all of the metals except for tantalum. If yes to decision point 302, then Eu, Pr, Nd, Dy, Fe, GA, and In 200 can be co-extracted from the e-waste 110 in process step 112 by, for example, using an acetic acid/hydrochloric acid/water solvent at 60° C. and shear forces. If no to decision point 302, then Eu, Pr, Nd, Dy, and Fe 202 can be extracted from the e-waste 110 in process step 114 by, for example, using an acetic acid solvent at 60° C. and applying shear forces. If no to decision point 300, then Eu 204 can be extracted from the e-waste 110 in process step 116 with a solvent, such as water. The next decision point 304 is whether to coextract metals from the residual e-waste leaving process step 116. If yes to decision point 304, then the next decision point 306 is whether to coextract Pr, Nd, Dy, and Fe. If yes to decision point 306, then Pr, Nd, Dy, and Fe can be coextracted in process step 114 by, for example, using an acetic acid solvent at 60° C. and applying shear forces. In this path, Pr, Nd, Dy, and Fe 202 (no Eu) would leave process step 114. If no to decision point 306, then Pr and Nd 206 can be coextracted in process step 118 by, for example, using water at 80° C. and applying shear forces. If no to decision point 304, Pr 208 can be extracted from the residua e-waste leaving step 116 in process step 120 by, for example, using water at 80° C. The residual e-waste leaving process step 112 can be treated to have Nd extraction in process step 122 by, for example, using water with NaOH as the solvent at 60° C. and applying shear force.

Dy and Fe can be coextracted from either the residual e-waste from process steps 118 or 120 in process step 124 by, for example, using an acetic acid solvent at 60° C. and applying shear forces. Ga and In 126 can be coextracted, from the residual e-waste leaving process step 114 or 124, in process step 126 by, for example, using an acetic acid/hydrochloric acid/water solvent at 60° C. and applying shear forces. Finally, Ta can be removed from the e-waste from process steps 112 or 126 in process step 128 using a photo/thermal refinement system. In the process paths described in FIG. 1, tantalum is the only metal that leaves in as an unreacted metal. Europium leaves as a metal hydroxide and the remaining metals leave as metal acetates. Optional refinement process steps 130 may be used to increase the concentrations of individual metals in streams 204-214. Non-limiting examples of refinement steps include separations based upon differences in magnetism, shape, size, density,

For an e-waste comprising the metals europium, praseodymium, neodymium, dysprosium, gallium, indium, iron, and tantalum, the flowsheet shows four possible product streams. A listing of the product stream combination with each stream denoted by its prominent metal product streams illustrated are i) two product streams with [Eu, Pr, Nd, Dy, Fe, Ga, & In] and [Ta], ii) three product streams with [EU, Pr, Nd, Dy, & Fe], [Ga & In], and [Ta], iii) four product streams with [Eu], [Pr, Nd, Dy, & Fe], [Ga & In], and [Ta], iv) five product streams with [Eu], [Pr & Nd], [Dy & Fe], [Ga & In], and [Ta], and v) six product streams with [Eu], [Pr], [Nd], [Dy & Fe], [Ga & In], and [Ta].

### EXAMPLES

Metals, rare earth and others, were obtained from Luciteira Science (Olympia Washington). Electronic waste, in the form of magnets containing rare earth and other metals, was obtained from Scott County (Iowa) Waste Commission. Individual metals and the electronic waste were used without further processing except for removal of the coating on the magnets and/or to mechanically reducing particle sizes. Glacial acetic acid, sodium hydroxide, hydrochloric acid, and deionized water were obtained from Fisher Scientific and/or Sigma and used without further processing.

### Example 1—Rare Earth Acetate Synthesis

As a general procedure, 0.5-2 grams of small chunks (<100 mg) of rare earth (i.e., holmium) were suspended in a 10% acetic acid solution (90 mL of deionized water and 10 mL of glacial acetic acid). The solution was stored in a round bottom flask with a stopper and monitored for changes. After approximately 1 week, the stopper was removed, allowing for evaporation of solvent and formation of precipitates. After approximately 2 weeks, the crystals were filtered out of the remaining solution. The same procedure was used with gallium and indium.

In this manner, Europium (III) Acetate, Praseodymium (III) Acetate, Neodymium (III) Acetate, Dysprosium (III) Acetate, Holmium (III) Acetate, Gadolinium (III) Acetate, Samarium (III) Acetate, Gallium (III) Acetate, and Indium (III) Acetate were produced. The individual compounds were characterized using Scanning Electron Microscope (SEM) and Energy Dispersive Spectroscopy (EDS). Making and characterizing the individual compounds gave evidence that these were the compounds made when separating electronic waste.

### Example 2—Preparation of Simulated e-Waste

An application for the present invention is the reclamation of electronic waste. A Simulated e-Waste was made by combining 0.19 g Europium, 0.34 g Praseodymium, 0.22 g Neodymium, 0.21 g Dysprosium, 0.38 g eutectic Gallium Indium, and 0.89 g Tantalum. This small sample of simulated e-waste was used for initial lab-scale experiments.

The simulated e-waste was subject to the process of this invention to recover valuable metals that can be upcycled. Example 3 through Example 7 corresponding to different separation steps shown in FIG. 1.

### Example 3—Recovery of Europium

2.2 g Simulated e-Waste from Ex. 2 was placed into a vial and 10-15 ml water was added with gentle stirring. The Europium Acetate was quickly extracted by and reacted with the water. Small particles of europium floated to the top of the container and formed a small layer of foam. After about one minute, the foam readily scraped away from the remaining e-Waste, which was particles of metal at the bottom of the vial. The remaining e-Waste and water were poured through a filter with filter paper. The filter did not allow the remaining metal pieces nor the small particles containing europium to pass. The remaining metal pieces were removed from the filter paper and rinsed with deionized water to ensure removal of any particles containing europium. The filter paper was allowed to dry, and the europium was recovered by brushing the particles off of the filter paper. The weight of the remaining metal was 2.04 g. The weight of the recovered europium was calculated, as the starting metals minus the ending metals, at 0.19 g and represented a <98% yield. The recovered particles were characterized using SEM and EDS and matched those of the europium (III) acetate from Example 1.

### Example 4—Recovery of Praseodymium

The 2.04 g of remaining simulated e-Waste after Example 3 was placed into a vial and 15 ml of water was added with gentle stirring. Heat was added via water bath raising the temperature from ambient to 80° C. The contents were observed to turn green as the praseodymium was extracted into the warm water and began forming small green particles. After several hours, the water with the praseodymium precipitate and remaining Simulated e-Waste material was poured through a filter with filter paper. The filter did not allow the remain metal pieces nor the small particles containing praseodymium to pass. The remaining metal pieces were removed from the filter paper and rinsed with deionized water to ensure removal of any particles containing praseodymium. The filter paper was allowed to dry, and the praseodymium was recovered by brushing the particles off of the filter paper. The weight of the remaining metal was 1.7 g. The weight of the recovered praseodymium was calculated, as the starting metals minus the ending metals, at 0.34 g and represented a <98% yield. The recovered particles were characterized using Scanning Electron Microscope (SEM) and Energy Dispersive Spectroscopy (EDS) and matched those of the praseodymium (III) acetate from Example 1.

### Example 5—Recovery of Neodymium

The 1.7 g of remaining simulated e-Waste after Example 4 was placed into a container and 15 ml of a solution of sodium hydroxide in water (pH of 10) was added to the container. While the other metals formed passive oxide layers and remained as metal pieces dispersed in the solution, the neodymium was extracted into the high pH solution and small neodymium particles precipitated. After several hours the high pH solution with the neodymium precipitate and remaining e-Waste material was poured through a filter with a filter paper. The filter paper did not allow the remain metals pieces nor the small particles containing neodymium to pass. The remaining metal pieces were removed from the filter paper and rinsed with deionized water to ensure removal of any particles containing neodymium. The filter paper was allowed to dry, and the neodymium was recovered by brushing the particles off of the filter paper. The weight of the remaining metal was 1.48 g. The weight of the recovered neodymium was calculated, as the starting metals minus the ending metals, at 0.21 g and represented a <98% yield. The recovered particles were characterized using Scanning Electron Microscope (SEM) and Energy dispersive spectroscopy (EDS) and matched those of the neodymium (III) acetate from Example 1.

### Example 6—Recovery of Dysprosium and Iron

1.48 g of remaining simulated e-Waste after Example 5 was placed into a vial and 15 ml of an acetic acid/water solution having a 3.9 pH was added to the container. The temperature was increased to 60° C. (using a water batch) and shear was maintained using a stir bar with a rpm of 800. The dysprosium and iron were extracted into the low pH solution and formed small particles. The low pH solution with the dysprosium particles, the iron particles, and the remaining e-Waste material was poured through a filter with a filter paper. The filter paper did not allow the remain metals pieces nor the small dysprosium particles and iron particles to pass. The remaining metal pieces were removed from the filter paper and rinsed with deionized water to ensure removal of any dysprosium particles and iron particles. The filter paper was allowed to dry, and the dysprosium and iron was recovered by brushing the particles off of the filter paper. The weight of the remaining metal was 1.27 g. The weight of the recovered dysprosium and iron was calculated, as the starting metals minus the ending metals, at 0.21 g and represented a <98% yield. The recovered particles were characterized using Scanning Electron Microscope (SEM) and Energy dispersive spectroscopy (EDS) and matched those of the dysprosium (III) acetate from Example 1.

### Example 7—Recovery of Gallium and Indium

An acetic acid/water solution as described in Example 6 was mixed with hydrochloric acid in a volume ratio of acetic acid to hydrochloric acid of 10:1 to produce an acetic acid/water/hydrochloric solution with a pH of 2. The 1.27 g of remaining simulated e-Waste after Example 6 was placed into a vial and 15 ml of the acetic acid/water/hydrochloric acid solution was added to the container. The temperature was increased to 60° C. (using a water bath) and shear was maintained by using a stir bar with a rpm of 800. The gallium and indium were extracted into the low pH solution and formed small particles. The low pH solution with the gallium particles, indium particles, and remaining e-Waste material was poured through a filter with filter paper. The filter paper did not allow the remain metals pieces nor the small gallium particles and indium particles to pass. The remaining metal pieces were removed from the filter paper and rinsed with deionized water to ensure removal of any gallium particles and indium particles. The filter paper was allowed to dry, and the gallium and indium was recovered by brushing the particles off of the filter paper. The weight of the remaining metal was 0.89 g. The weight of the recovered gallium and indium was calculated, as the starting metals minus the ending metals, at 0.38 g and represented a <98% yield. The recovered particles were characterized using Scanning Electron Microscope (SEM) and Energy dispersive spectroscopy (EDS) and matched those of the gallium (III) acetate and indium (III) acetate from Example 1.

### Example 8—Europium Inorganics Synthesis

As a general procedure, 0.5-2 grams of small chunks (<500 mg) of europium were suspended in either water or a 10% acid solution (90 mL of solvent and 10 mL of acid). In Ex. 8, water was used instead of an acid and the solvent was water. The solution was stored in a round bottom flask with a stopper and monitored for changes. After approximately 1 week, the stopper was removed, allowing for evaporation of solvent and formation of precipitates. After approximately 2 weeks, the crystals were filtered out of the remaining solution.

### Examples 9-25—Varied Europium Inorganics Synthesis

Example 8 was repeated varying water and/or the acid or water from among water, formic acid, acetic acid, propionic acid, butyric acid, and valeric acid (1 to 5 carbon atoms), and/or varying the solvent from among water, methanol, and ethanol (0 to 2 carbon atoms). Table 1 shows which combination of water/acid and solvent were used in each of the Examples.

TABLE 1
Examples 8-25 Europium Inorganics Synthesis

| Example | Acid or Water | Solvent |
|---|---|---|
| 8 | Water | Water |
| 9 | Formic acid | Water |
| 10 | Acetic acid | Water |
| 11 | Propionic acid | Water |
| 12 | Butyric acid | Water |
| 13 | Valeric acid | Water |
| 14 | Water | Methanol |
| 15 | Formic acid | Methanol |
| 16 | Acetic acid | Methanol |
| 17 | Propionic acid | Methanol |
| 18 | Butyric acid | Methanol |
| 19 | Valeric acid | Methanol |
| 20 | Water | Methanol |
| 21 | Formic acid | Methanol |
| 22 | Acetic acid | Methanol |
| 23 | Propionic Acid | Methanol |
| 24 | Butyric acid | Methanol |
| 25 | Valeric acid | Methanol |

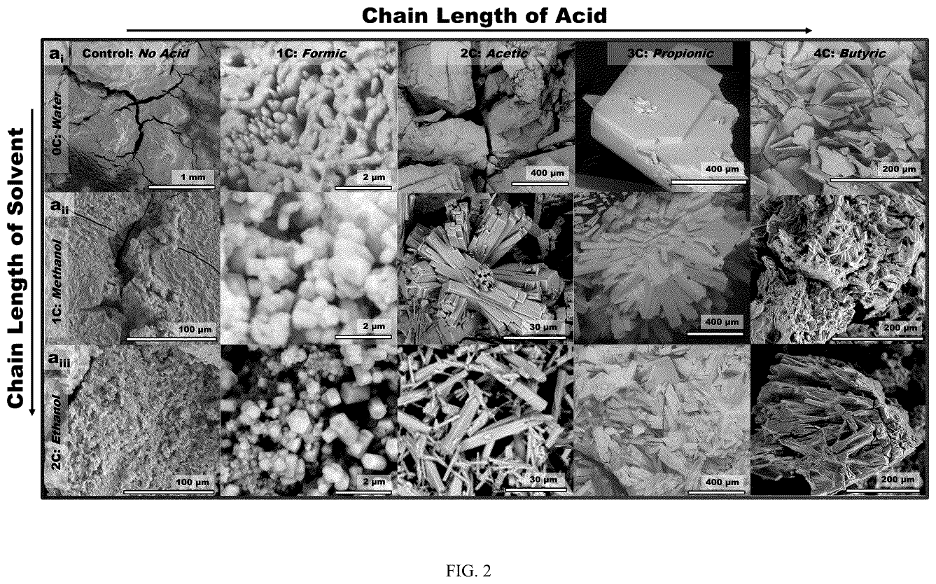

FIG. 2 shows the SEM images of the different particles for the compounds of Examples 8-12, 14-18, and 20-25. FIG. 2 shows that the size and the shape of the metal particles comprising europium can be varied by varying the solvent and/or acid used in the separation process. Particle size and shape can be used further downstream in a separation process to separate particles of different metals.

### Examples 26(a)-26(c)—Post Processing: Tuning Via Metal Center

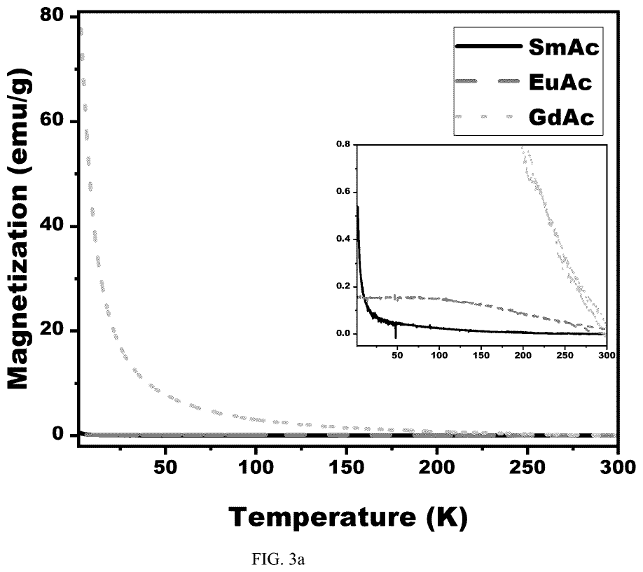

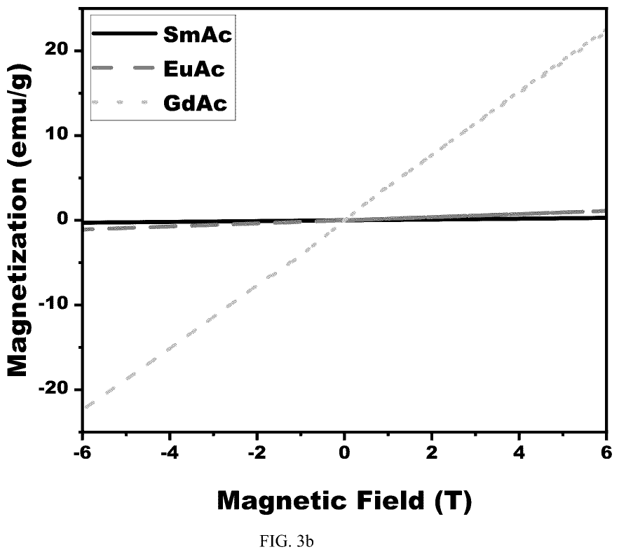

A Superconducting Quantum Interference Device (SQUID) Quantum Design MPMS3 was used to analyze the magnetization (M) versus temperature (T) at a constant applied field of 25 kOe for (a) samarium (III) acetate, (b) europium (III) acetate, and (c) gadolinium (III) acetate. The Moment (VSM) was collected across 300 K to 15 K, with a delay of 30 seconds, and then sweeping back to 300 K, all at a rate of 4 K/min. FIG. 3a shows the graph of magnetization versus temperature for the three compounds.

### Examples 27(a)-27(c) Post Processing: Tuning Via Metal Center

A Superconducting Quantum Interference Device (SQUID) Quantum Design MPMS3 was used to analyze the magnetization (M) versus the applied field (H) at a constant temperature of 50 K for (a) samarium (III) acetate, (b) Europium (III) acetate, and (c) gadolinium acetate. The Moment (VSM) was collected from 0 to 1000 Oe at a rate of 100 Oe/sec, from 1 kOe to 60 kOe to 1 kOe at a rate or 500 Oe/sec, from 1 kOe to −1 kOe at a rate of 100 Oe/sec, from −1 kOe to −60 kOe to −1 kOe at a rate of 500 Oe/sec, from −1 kOe to 1 kOe at a rate of 100 Oe/sec, and finally 1 kOe to 60 kOe at a rate of 500 Oe/sec. FIG. 3b shows the graph of magnetization versus applied field for the three compounds.

### Example 28—Europium (III) Acetate in an Altered Magnetic State

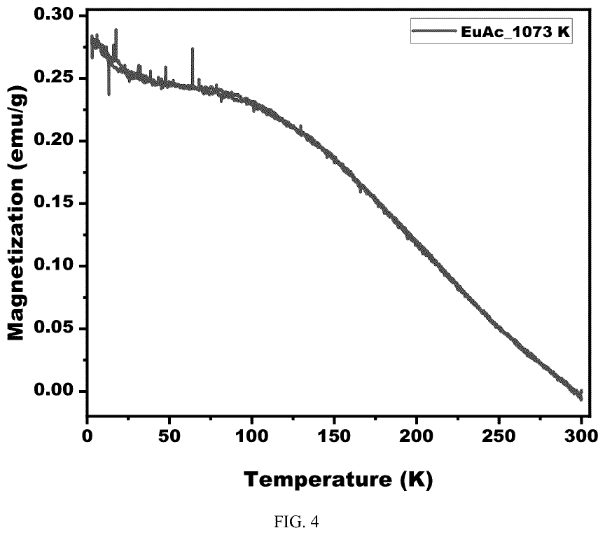

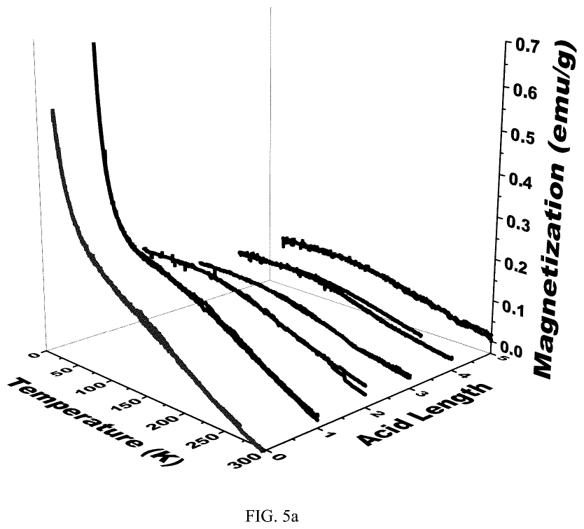

Europium (III) acetate made in Example 1 was heated under an argon atmosphere at 1073 K. FIG. 4 shows the Magnetization versus temperature, which was captured as described in Ex. 26. The magnetization versus temperature graph shows a spin glass behavior. Typical magnetization is adjusted for mass, but further adjustment has been made to account for differences in density, a state function.

### Examples 29(a)-29(f)—Post Processing: Data-Tuning Via Chain Length

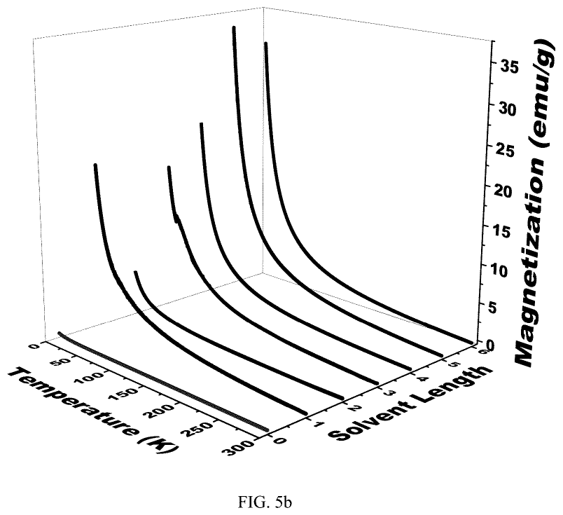

Example 26 was repeated to analyze the magnetization (M) versus temperature (T) at a constant applied field of 25 kOe for Europium and for the Europium-containing products from Examples. 9-13. Results are shown in FIG. 5a.

### Examples 30(a)-30(f)—Post Processing: Data-Tuning Via Chain Length

Example 27 was repeated to analyze the magnetization (M) versus the applied field (H) at a constant temperature of 50 K for Europium and for the Europium-containing products from Examples 9-13. Results are shown in FIG. 5b.

### Examples 31(a)-31(c)—Post Processing: Data-Tuning Via Temperature

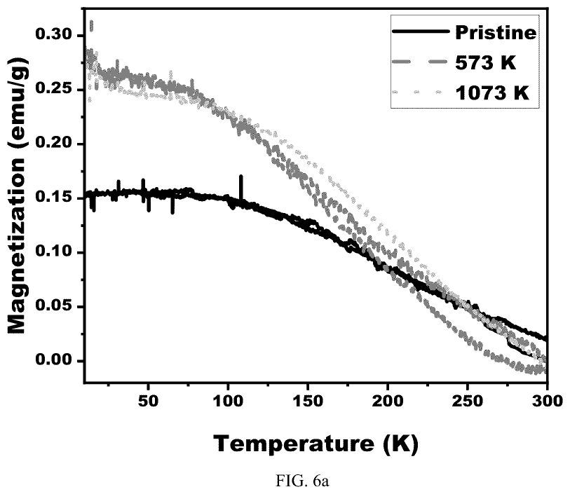

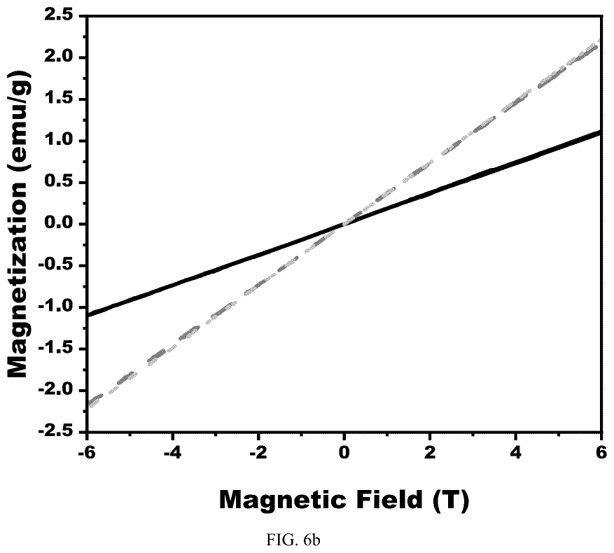

Example 26 was repeated to analyze the magnetization (M) versus temperature (T) at a constant applied field of 25 kOe for a) Europium (III) acetate which had undergone no heat treatment (Pristine), b) Europium (III) acetate which had been held under an argon atmosphere at 573 K for two hours (573 K), and c) Europium (III) acetate which had been held under an argon atmosphere at 1073 K for two hours (1073 K). Results are shown in FIG. 6a

### Examples 32(a)-32(c)—Post Processing: Data-Tuning Via Temperature

Example 27 was repeated to analyze the magnetization (M) versus the applied field (H) at a constant temperature of 50 K for a) Europium (III) acetate which had undergone no heat treatment (Pristine), b) Europium (III) acetate which had been held under an argon atmosphere at 573 K for two hours (573 K), and c) Europium (III) acetate which had been held under an argon atmosphere at 1073 K for two hours (1073 K). Results are shown in FIG. 6b.

### Examples 33(a)-33(c)—Post Processing: Data-Tuning Via Temperature

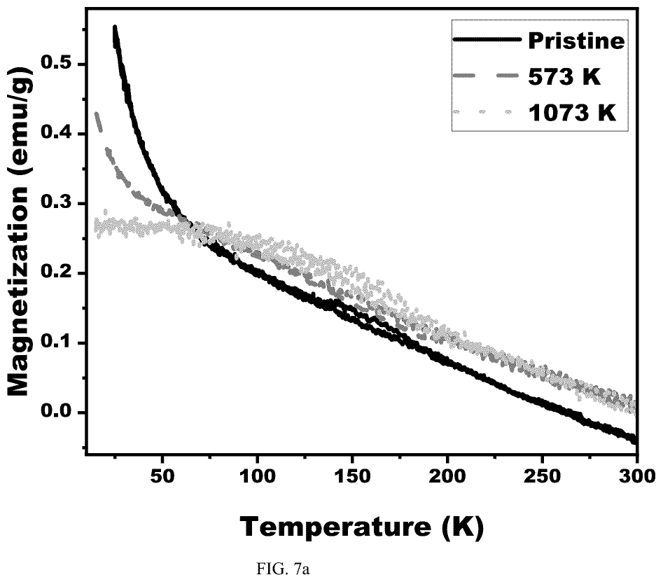

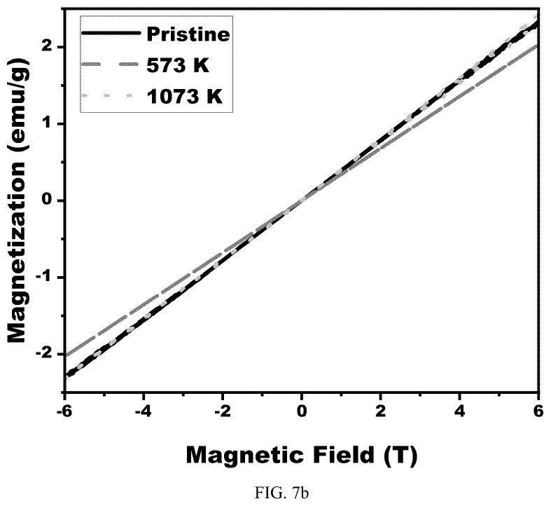

Example 26 was repeated to analyze the magnetization (M) versus temperature (T) at a constant applied field of 25 kOe for the Europium-water (control) of Example 9 with various heat histories: a) Europium-water which had undergone no heat treatment (Pristine), b) Europium-water which had been held under an argon atmosphere at 573 K for two hours (573 K), and c) Europium-water which had been held under an argon atmosphere at 1073 K for two hours (1073 K). Results are shown in FIG. 7a

### Examples 34(a)-34(c)—Post Processing: Data-Tuning Via Temperature

Example 27 was repeated to analyze the magnetization (M) versus the applied field (H) at a constant temperature of 50 K r the Europium-water (control) of Example 9 with various heat histories: a) Europium-water which had undergone no heat treatment (Pristine), b) Europium-water which had been held under an argon atmosphere at 573 K for two hours (573 K), and c) Europium-water which had been held under an argon atmosphere at 1073 K for two hours (1073 K). Results are shown in FIG. 7b.

### Equipment Setup for Scaled-Up Separations, Examples 35-41

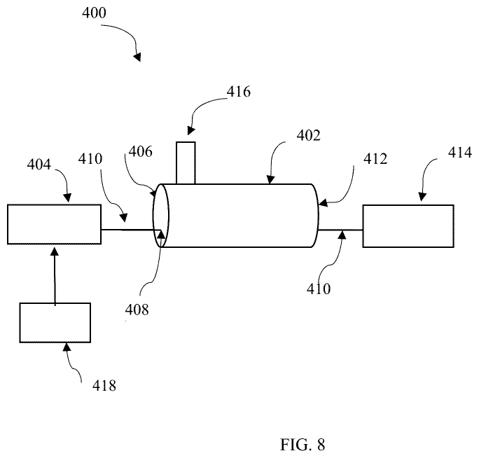

Larger scale experiments were performed in the medium-scale equipment 400 shown in FIG. 8. The extraction chamber 402 was made of a 4 in. diameter and 13 in. long stainless-steel pipe. At the side closest to the motor 404, the chamber 402 was isolated using a stainless-steel cap 406 of 5 in. diameter and 2 in. thickness. The cap 406 was machined using a CNC, with a hole 408 for the rotor 410 and the bearing (ID 0.5 in., OD 0.8 in.) at a 0.5-inch offset from the center of the cap 406. The offset placement of the rotor 410 introduced asymmetry in the shear profile, thus reducing the dead zones and maximizing the shear force. The cap 406 was welded to the chamber 402. A 4-inch diameter plumber's plug 412 was used to seal the chamber end distal to the motor 404. The motor 404 was connected via a universal coupling to the drill head (not shown) which housed the 0.5-inch diameter and 16-inch-long rotor 410. The rotor 410 was machined to be able to attach different screw heads (not shown). The screw heads acted as impellers during shear. A stainless-steel housing 414 was machined with a brass bearing to hold the rotor 410 on the chamber end distal to the motor 404. A short 2-inch diameter stainless steel pipe 416 was welded on the top of the extraction chamber as the inlet for solvent and metals. RPM controller 418 was used to set the rotations per minute (rpm) for the rotor 410.

### Example 35—Extraction of Europium

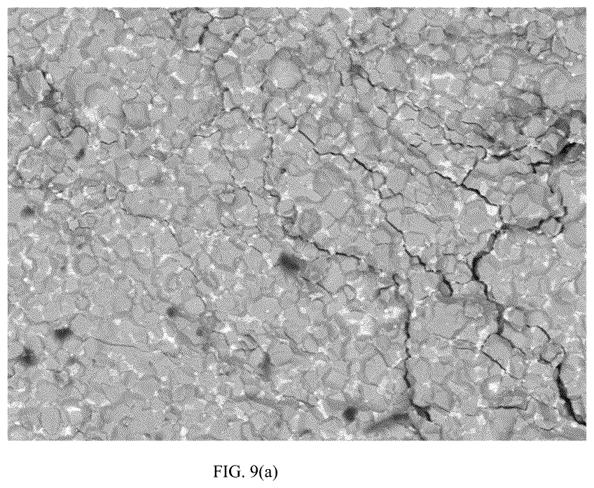

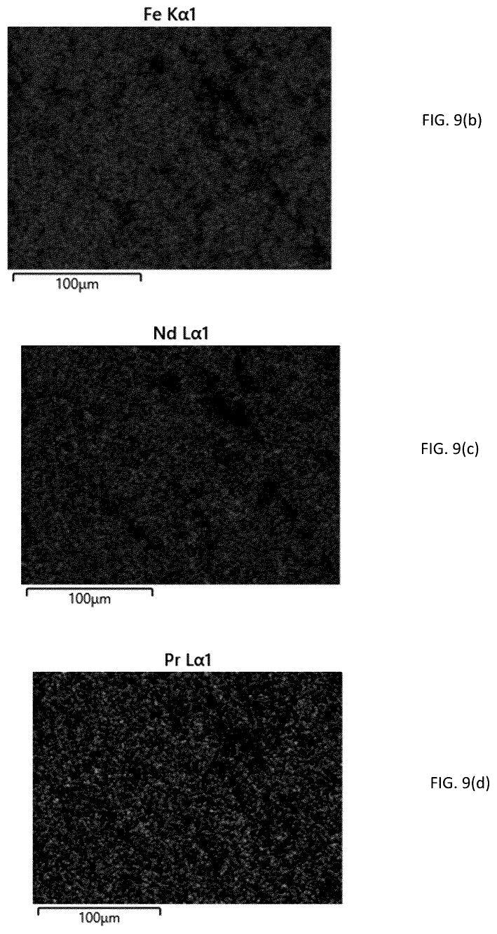

A solvent comprising 1000 ml of DI water was poured into the extraction chamber through the feed pipe. A metal mixture comprising 10 g broken magnets, 5 g europium, 7 g neodymium, 5 g praseodymium, and 5 g dysprosium, was added through the feed pipe to the solvent in the extraction chamber. The broken magnets were characterized using SEM and EDS. The SEM image is shown in FIG. 9(a), EDS images FIG. 9(b) shows Fe, FIG. 9(b) shows Nd, and FIG. 9(c) shows Pr FIG. 9(d). The colored EDS overlay of the metals showed that the metals were well dispersed in the magnet. The measured composition is given in Table 3. The weight ratio of Fe:Nd in the magnet is 2:1.

TABLE 3
EDS Spectrum of Reclaimed Magnets -

| Element | Weight % |
|---|---|
| Fe | 63.42 |
| Nd | 31.67 |
| Pr | 4.908 |
| Total | 100.00 |

No heat or shear (the motor was off) where added to the mixture. Within a few minutes, europium extracted into the water and the contents were removed from the extraction chamber and poured through a metal sieve. The remnant metal mixture remained on the sieve and the liquid with the extracted europium were collected below the sieve. The remnant metals were washed to remove extracted europium that remained on the surface and weighted 27.5 g.

### Example 36—First Extraction of Praseodymium

A solvent comprising 1000 ml of DI water was poured into the extraction chamber through the feed pipe. The remnant metal mixture from Ex. 35 was added through the feed pipe to the solvent in the extraction chamber. The motor control was set for 40 rpm of the rotor and the motor was turned on. No heat was added; the example was run at room temperature. The metal mixture and solvent remained in the chamber, under shear, for 4 hours. After four hours, the contents were removed from the extraction chamber and poured through a metal sieve. The remnant metals mixture remained on the sieve and the liquid with the extracted metals were collected below the sieve. The remnant metals mixture was washed to remove extracted praseodymium that remained on the surface. The remnant metal mixture weighed ˜24 g. The liquid was evaporated, and the extracted metals were analyzed using SEM and EDS. The EDS results show 51.9 wt. % carbon, 21.8 wt. % oxygen, 21.6 wt. % praseodymium and 4.6 wt. % europium. The measured carbon is not part of the metal but is simply an artifact of working with the extracted metal sample on carbon tape. Table 4 shows that the metal extract content was mostly praseodymium. The europium is likely from contamination in the chamber that occurred during Ex. 35 or was left on the metal after washing of the remnant metal of Ex. 35. On a metals-only basis, the recovered metals were 82.4 wt. % praseodymium and 17.6 wt. % europium.

TABLE 4

| Element | Weight % |
|---|---|
| Pr | 82.4 |
| Eu | 17.6 |

While the flowsheet in FIG. 1 shows praseodymium being extracted at higher temperature, the medium-scale unit did not have the ability to add heat. Shear was used as an alternative stressor for creating lower energy points in the thermodynamic energy landscape.

### Example 37—Second Extraction of Praseodymium

By material balance, all of the praseodymium in the metal mixture had not been extracted under the conditions of Example 36. Therefore, Example 36 was repeated using the remnant metal mixture from Ex. 36, except the contents remained in the extraction chamber for 6 hours. With the longer extraction time, not only did praseodymium extract into the solvent, so did small amounts of dysprosium, neodymium, iron, and aluminum. The composition of the extracted metal is shown in Table 5.

TABLE 5

| Element | Weight % |
|---|---|
| Pr | 63.0 |
| Eu | 27.9 |
| Dy | 4.0 |
| Nd | 3.1 |
| Fe | 2.0 |

### Example 38—First Extraction of Neodymium

Example 37 was repeated except that the solvent comprised 10 g of NaOH in 1000 ml of DI water (13-14 pH), the remnant metal mixture from Ex. 37 was added to the chamber, and the contents remained in the extraction chamber under shear for 24 hours. The remnant metal mixture weighed 21.95 g. The composition of the extracted metal is shown in Table 6.

TABLE 6

| Element | Weight % |
|---|---|
| Nd | 73.9 |
| Pr | 15.9 |
| Eu | 4.3 |
| Dy | 4.3 |

### Example 39—Second Extraction of Neodymium

Example 39 was repeated using the remnant metal mixture from Ex. 38. The composition of the extracted metal is shown in Table 7.

TABLE 7

| Element | Weight % |
|---|---|
| Nd | 80.0 |
| Pr | 12.4 |
| Eu | 4.1 |
| Dy | 4.1 |

### Example 40—Neodymium Yield Versus Time

To further understanding the rate of neodymium extraction over time, a solvent comprising 15 g of NaOH in 1500 ml of DI water (13-14 pH) was poured into the extraction chamber through the feed pipe. 24 g of neodymium was added to the solvent. No heat was added; the example was run at room temperature. The motor control was set for 25 rpm and the motor was turned on. After 30 minutes, the contents were removed from the extraction chamber and poured through a metal sieve. The remnant metals mixture remained on the sieve and the liquid with the extracted metals were collected below the sieve. The remnant metals mixture was washed to remove extracted neodymium that remained on the surface. The remnant metals mixture was weighed, and the weight loss calculated. The process was repeated, taking the remnant metals mixture and fresh solvent, and placing them under shear. Analysis was done at the accumulated time in the extraction chamber as noted in Table 8.

TABLE 8

| Accumulated | | | Weight Loss |
|---|---|---|---|
| Time (minutes) | Weight (grams) | Percentage | (grams) |
| 0 | 24.0 | 100% | 0 |
| 30 | 24.0 | 99.8% | 0.04 |
| 60 | 23.9 | 99.6% | 0.09 |
| 180 | 23.4 | 97.4% | 0.61 |
| 300 | 23.0 | 95.8% | 1.00 |
| 720 | 22.9 | 95.3% | 1.13 |

### Example 41—Continued Nd Yield Versus Time

Example 40 was continued starting with the remnant metals mixture after an accumulated extraction time of 720 minutes. For this example, with the motor control was set for 50 rpm and time reset to 0. The amount of extraction was analyzed after 720 minutes and again after 1440 minutes of extraction at the 50 rpm shear condition. Results are given in Table 9.

TABLE 9

| Time (minutes) | Weight (grams) | Percentage | Weight Loss (grams) |
|---|---|---|---|
| 0 | 22.9 | 100% | 0 |
| 720 | 22.1 | 96.8% | 0.72 |
| 1440 | 22.6 | 98.8% | 0.28 |

### Example 42—Coextraction from Reclaimed Magnets

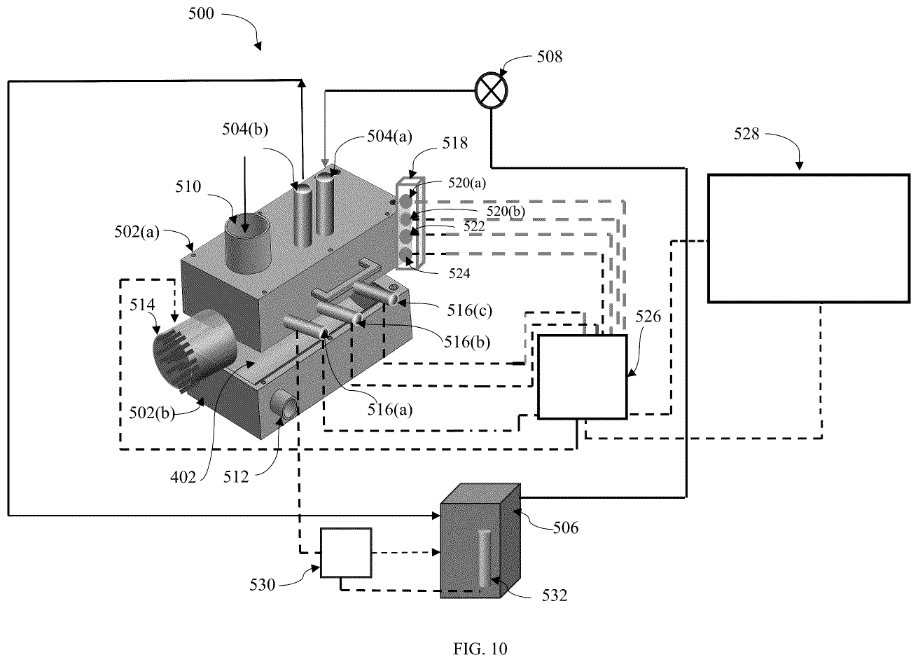

Even larger scale magnet recycling was performed in the large-scale equipment 500 shown in FIG. 10 The chamber 402 was machined from two 24 in long and 12 in wide solid stainless-steel blocks 502(a) and 502(b). Both parts were machined such that when blocks 502(a) and 502(b) were placed together, a cylindrical chamber 402 with 5 in radius and length of 22 in was formed. The chamber 402 was offset in the blocks 502(a) and 502(b) in that the majority of the volume of the chamber 402 was in the top block 502(a). The top block 502(a) had two 0.25 inch diameter ports, 504(a) for feeding hot water from a heated water reservoir 506 to a heat exchanger made of ¼ inch bent stainless steel tubing (not shown) located within the upper section of the chamber 402 and port 504(b) for returning cool water to the heated water reservoir 506. Pump 508 pumped water from the heated water reservoir 506 into the heat exchanger through port 504(a) and out of the heat exchanger through port 504(b) and back to the heated water reservoir 506. The top block 502(a) also had a 4.5 inch diameter inlet 510 for feeding the metals and the chemicals into the chamber 402. The bottom block 502(b) had an outlet port 512 connected to a ball valve (not shown) that was used to extract the materials. A custom silicone O-ring (not shown) was used to seal blocks 504(a) and 504(b). The motor 514 was used to turn the shaft (not shown) within the chamber 402 when examples were run.

In-situ measurements were done using sensors connected to the ports 516(a), 516(b) and 516(c) on the side of block 502(a). Thermocouple sensors (not shown) were connected to the ports 516(a) and 516(b), and a pressure sensor (not shown) was connected to the port 516(c) to obtain the temperature and the pressure of the fluid-magnet mix. A sensor array 518 comprising of 2 turbidity sensors 520(a) and 520(b), a pH sensor 522 and a total dissolved solids sensor 524 was connected to another port (not shown) to measure in situ reaction dynamics. Mechanical force was applied via a 2 HP motor 514 connected to a shaft with circular blades (not shown) and a stator (not shown) was used to increase the shear and reduce dead zones in the chamber 402. The stator was a stationary hollow pipe that surrounded the rotor and circular blades with long rectangular slots. The stator heled to make the flow field more turbulent and asymmetric.

Monitoring of the process was done using a raspberry PI microprocessor 526 with the sensors 520(a), 520(b), 522, 524 and the temperature and pressure sensors (not shown) from ports 516(a), 516(b), and 516(c) connected to the GP/IO ports (not shown) and the motor 514 to the PWM port (not shown). A touchscreen display 528 was used with an HTML interface to monitor the live sensor readings and control motor 514 rpm. Live recordings of inside and outside the chamber 402 were captured via an endoscopic camera (not shown) and a webcam (not shown) to monitor the reaction and safety during operation. The circuit had an external emergency switch (not shown) as a safety measure in case of emergencies.

The temperature of the heated water reservoir 506 was controlled by temperature control unit 530 by modifying the energy output of the immersion heater 532. The temperature sensor (not shown) connected to port 516(a) and monitoring the temperature of the fluid-magnet mix and a temperature sensor (not shown) located within the heated water reservoir 506 served as input the temperature control unit 530.

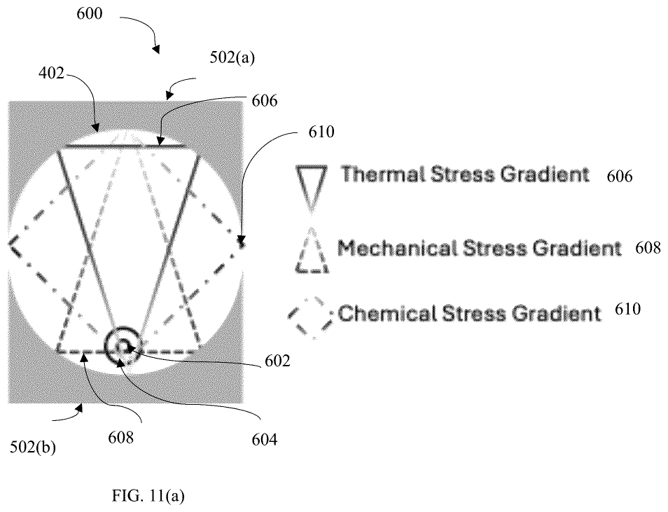

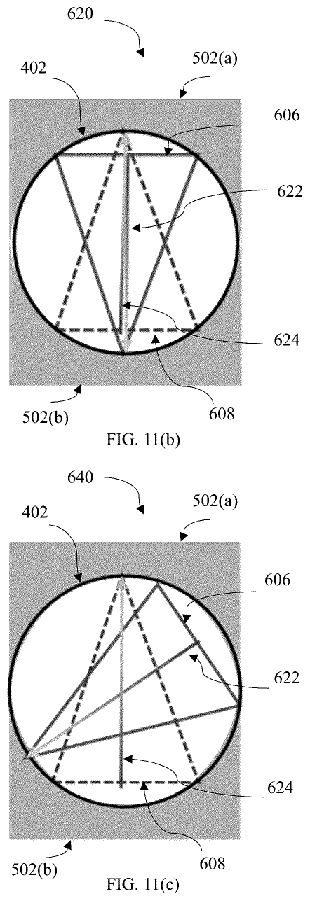

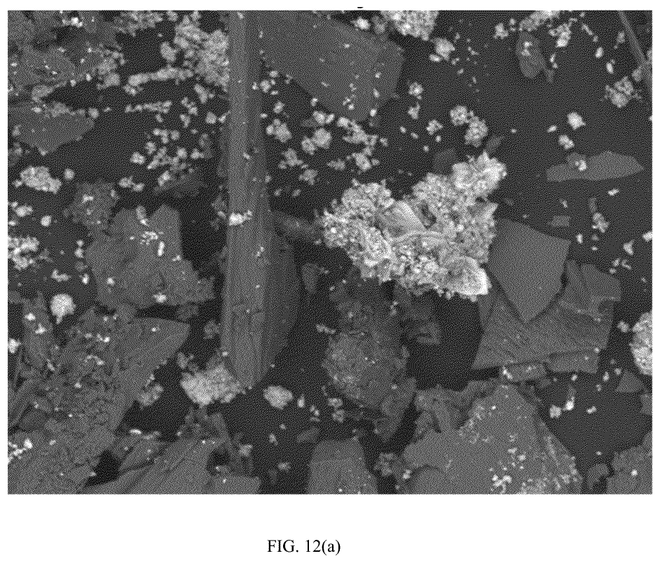

FIG. 11(a) is a schematic 600 of a side view of the extractor 402 under conditions run in Example 42. The rotor 602 with its blades (not shown) is surrounded by the stator 604. The heater (not shown) in the top portion of the extractor 402 causes a thermal stress gradient (or asymmetric thermal stress) 606. The thermal stress imparted by the heater is stronger toward the top of horizontal extractor 402 and decreases the further from the heater, such that the smallest thermal stress is on the solution closest to the bottom of the extractor 402. In other words, there is a temperature gradient from the top to the bottom of the extractor 402. The mechanical stress gradient 608 is caused by the mechanical energy imparted by the rotor 602, blades (not shown) attached to the rotor, and the stator constricting flow. The mechanical stress gradient (or asymmetric mechanical stress) 608 is caused by the mechanical stress being strongest near the bottom of the extractor 402 as the rotor 602 and stator 604 are located near the bottom of the extractor 402. The combination of the thermal stress gradient 606 and the mechanical stress gradient 608, impacts the distribution of the acid in the extractor 402. Consequently, the concentration of acid is highest at the center and decreases near the top and the bottom causing a chemical stress gradient (gradient in the reactivity) 610 to occur.

FIG. 11(b) is a schematic 620 of the extractor as shown in FIG. 11(a), showing the asymmetric thermal stress 606 and the asymmetric mechanical stress 608. FIG. 11(b) also shows the thermal stress vector 622 and the mechanical stress vector 624. The thermal stress vector 622 shows the general direction of decreasing thermal stress from where the heater is near the top of the extractor 402 downward. The mechanical stress vector 624 shows the general direction of decreasing mechanical stress from where the rotor and stator are near the bottom of the extractor 402 upward. In this schematic 620, the thermal stress vector 622 and the mechanical stress vector 624 are opposed to one another. FIG. 11c is a schematic 640 of the extractor as shown in FIG. 11(c) with the heater rotated around the circumference of the extractor 402, causing the asymmetric thermal stress 606 to move relative to FIG. 11(b). In FIG. 11(c), the thermal stress vector 622 and the mechanical stress vector 624 intersect within the extractor 402.

Reclaimed magnets from the Scott County waste commission, as characterized in Ex. 35 and FIGS. 9, were first crushed using a rolling mill then subsequently broken down using a handheld blender.

A solvent comprising of 19 l of DI water and 200 g NaOH was poured into the extractor 402 via the inlet port 510. 1 kg of crushed magnets were added through the inlet port 510 into the chamber. Heat was added by maintaining the temperature inside the chamber at 60 degrees Celsius via the heat exchanger 532. Shear was applied via the motor 514 at constant 1250 RPM for 96 hours. Samples were extracted via the outlet port 512 using a metal sieve (not shown). The remnant magnet mixture remained on the sieve and the liquid with the extracted metals were collected below the sieve. The liquid was evaporated, and the extracted metals were analyzed using SEM and EDS. The EDS results show 55.73 wt. % Iron, 32.11% Neodymium and 4.91 wt. % Praseodymium in the first sample collected on day 1.

After the large-scale equipment had been run, a refining step was implemented for the Nd. A 75-micron sieve was used with ethanol as the solvent to physically separate different sized and shape particles from the residue, in order to isolate the purest Nd particles. Samples were collected from the separated mixture and mounted on a carbon tape to get the SEM and EDS spectra. The result of the analysis is shown in the Refined column of Table 10.

TABLE 10
EDS of Extracted Metals from Reclaimed Magnets at different times

| | | Day 1 | Day 1 | Day 2 | Day 3 | Day 3 | Refined |
|---|---|---|---|---|---|---|---|
| Element | Magnets | Weight % | | | | | |
| Fe | 63.42 | 55.73 | 45.42 | 55.13 | 43.40 | 30.93 | 11.57 |
| Nd | 31.67 | 32.11 | 44.80 | 36.60 | 46.50 | 58.07 | 76.09 |
| Pr | 4.91 | 6.80 | 9.15 | 7.19 | 9.62 | 11.07 | 12.34 |
| Total | 100.00 | 100.00 | 100.00 | 100.00 | 100.00 | 100.00 | 100.00 |
| Fe:Nd | 2:1 | 1.73:1 | 1.01:1 | 1.5:1 | 1:1.07 | 1:1.87 | 1:6.57 |

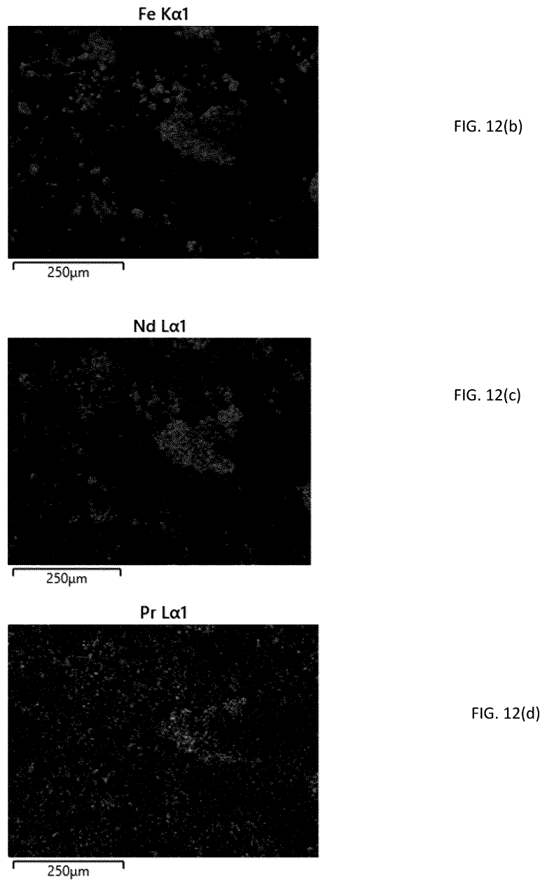

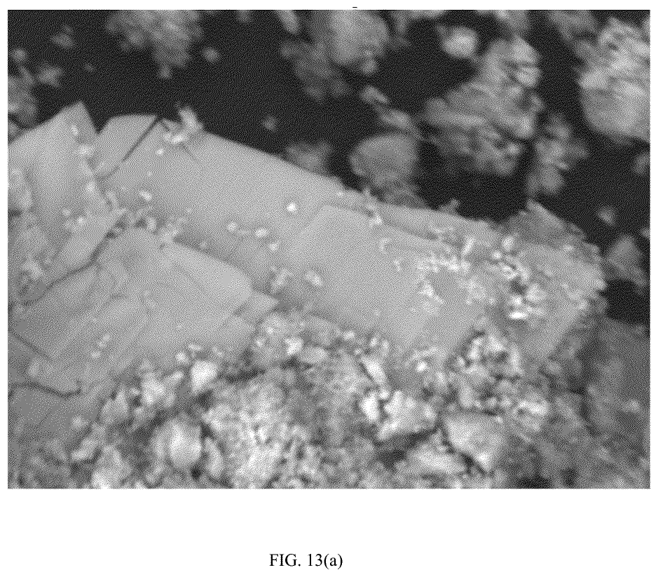

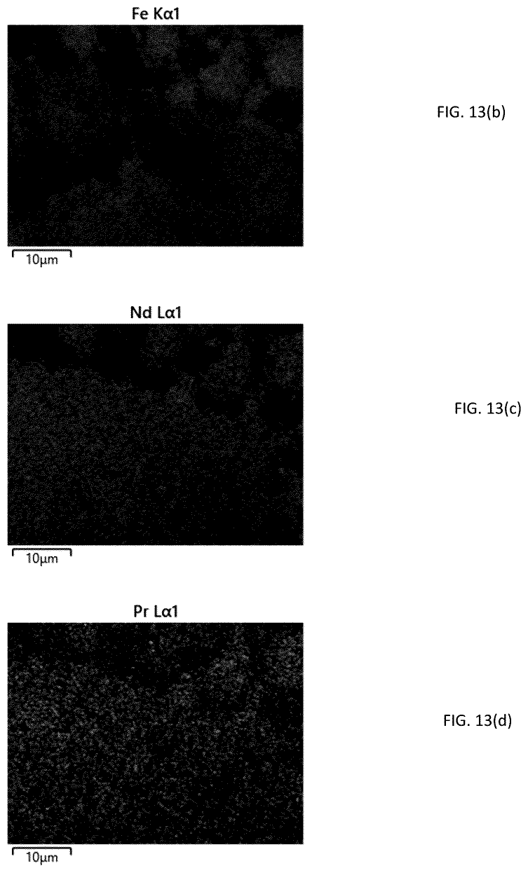

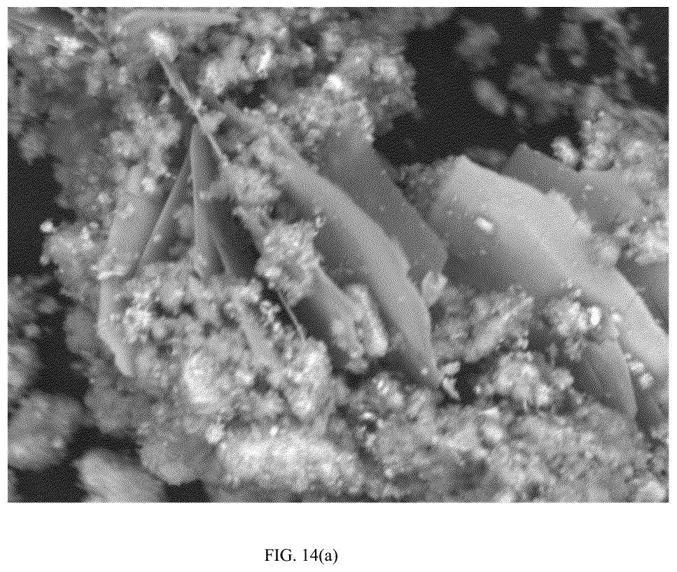

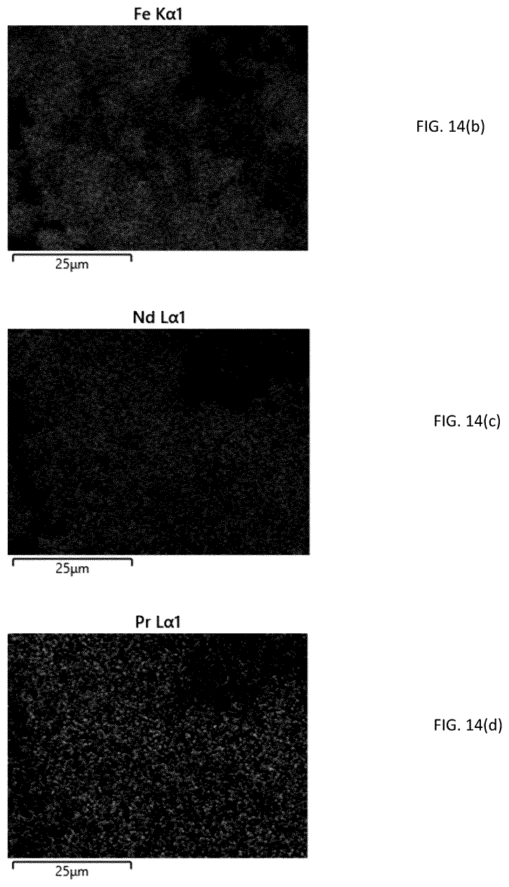

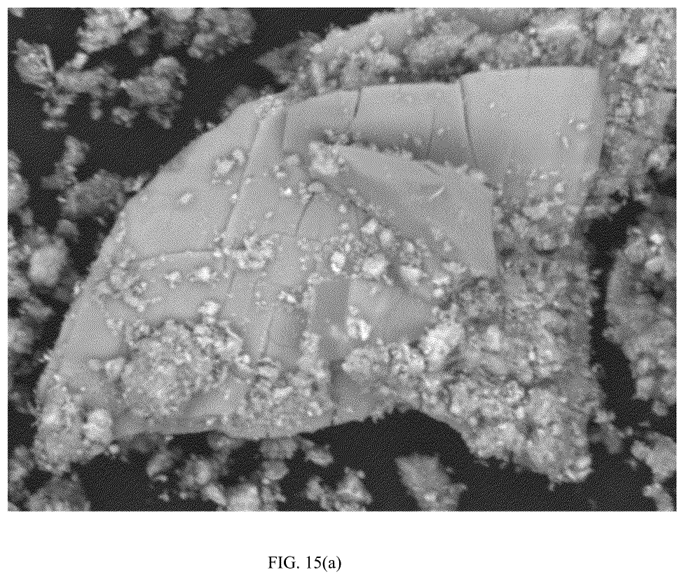

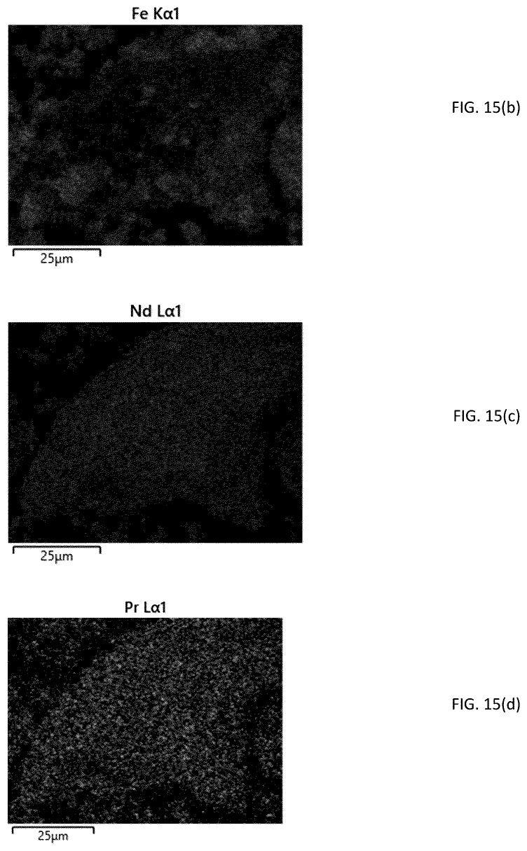

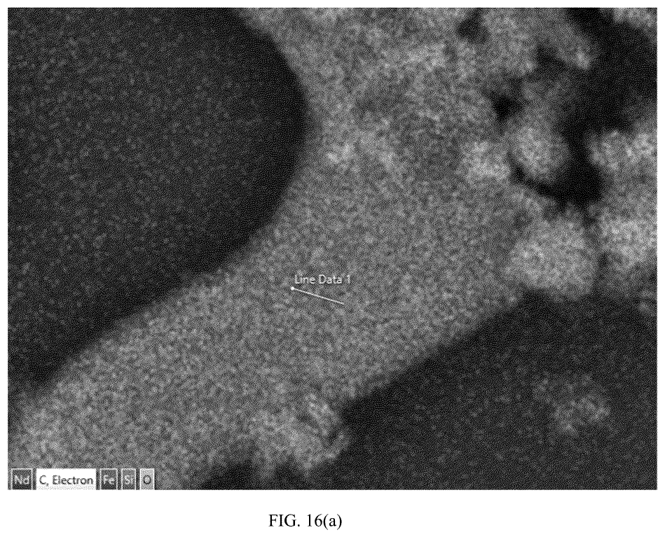

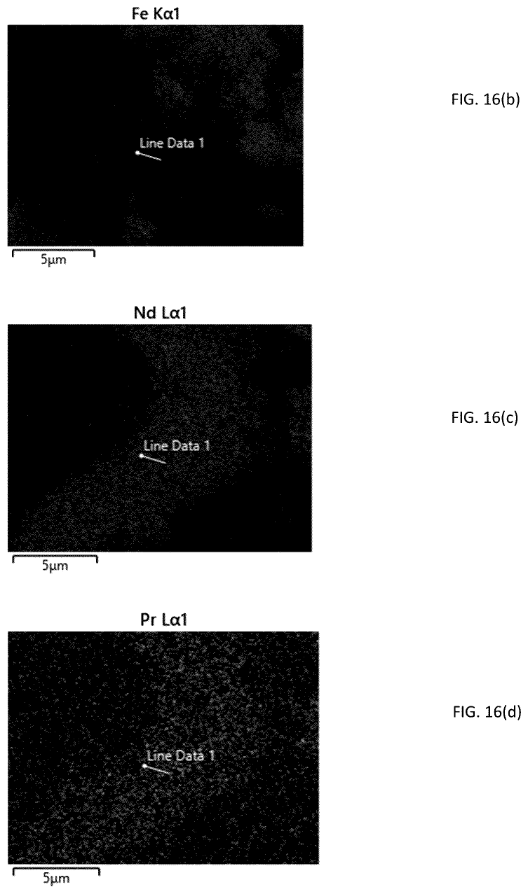

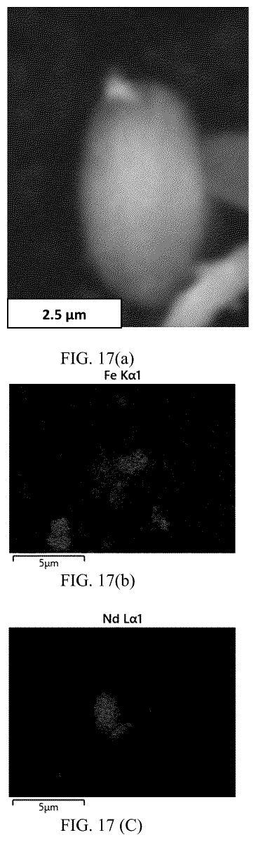

FIGS. 12-16 show Scanning Electronic Microscope (SEM) images of the extracted metals and EDS images of iron, neodymium, and praseodymium from each reported extraction in Table 5 on days 1-3, respectively. FIG. 17 shows the SEM image of the refined neodymium metal and EDS images of iron and neodymium

### Example 43—Enrichment of Neodymium

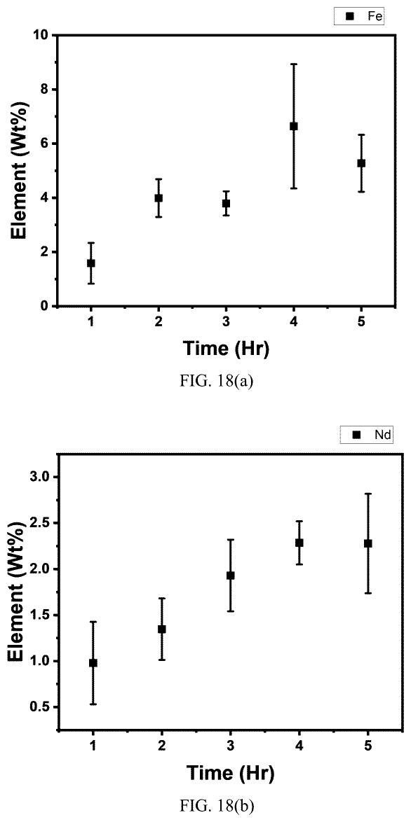

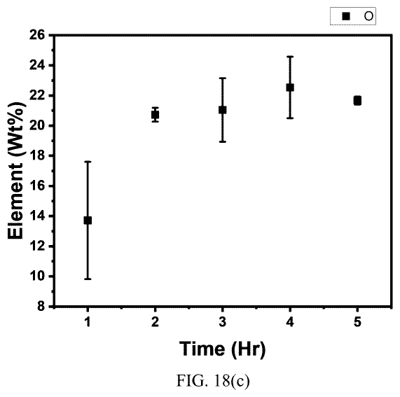

For further enrichment of the extracted metal, a solvent consisting of 0.5 g Phosphotungstic acid was mixed with 5 ml DI water in a scintillation vial and 0.5 g of the extracted and dried residue was added and mixed. No Heat or shear were added to the mixture. The mixture immediately turned blue and over time turned reddish grey. Samples were collected every 1 hour, and SEM-EDS was done. The EDS results show 23.66 wt. % oxygen, 5.06 wt. % carbon, 22.08 wt. % Iron, 41.36 wt. % Tungsten, 5.92 wt. % Neodymium and 1.25 wt. % Praseodymium. Measured tungsten is due to its presence in the acid and is not part of the metal. Selective separation of iron from the mixture can be seen FIGS. 18(a) and 18(b) wherein a ratio of 3.7:1 of iron to neodymium can be extracted.

### Example 44—Magnet Upcycling

150 g e-waste (magnets without their coatings and broken with a hammer) was heated using a propane torch for 5 minutes to remove any remnant magnetization. The e-waste was then placed in a glass beaker and a solution containing 10 ml acetic acid and 1500 ml DI water were added to the beaker. A handheld immersion blender was used to shear the mixture for 5 minutes out of each 30 minutes over a period of 3 hours. The mixture was left to react for at least 48 hours. The remaining slurry was collected in a glass dish and placed in a furnace at 100° C. for approximately 3 to 4 hours until complete dehydration. The residue was collected and placed in a furnace with a nitrogen environment. The furnace temperature ramped up at a rate of 100° C./hr. for 10 hours to reach a temperature of 1,000° C. and then held at the final temperature for 1 hour before the heat source to the furnace was turned off and allowed to return to ambient conditions. The powder was collected, and an initial press was done using a hydraulic press to break down bigger particles. The powder residue was passed through a metal sieve to remove any remaining larger particles to improve compactness. Borax (1% by weight) was then added to the powder and mixed thoroughly. Next steps in the process, the mixture Borax/powder mixture will be placed in plasma to facilitate the metal/Borax reactions and then a hydraulic press in a magnetic field is to be used to form magnets.

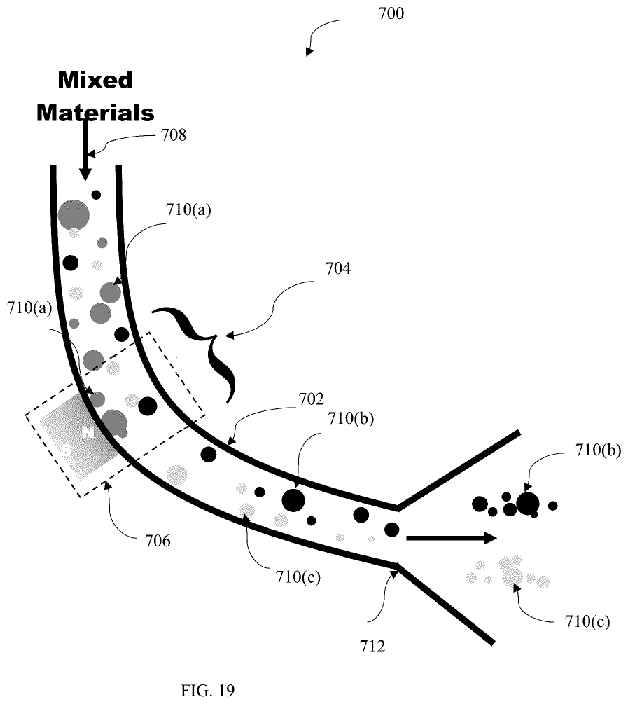

FIG. 19 shows a schematic of a magnetizable bent pipe separation system 700 form a side view (i.e., the pipe 702 is vertically oriented, the supports are not shown). Pipe 702 has a curved section 704 to impart centrifugal forces on the solution flowing through the pipe 702. A reversible magnet 706 is shown on the curved section 704 of the pipe 702. The mixed material feed 708 is made up of particle types 710(a), 710(b), and 710(c) in a fluid. Each particle type 710(a), 710(b), and 710(c) can vary in size (as shown in FIG. 19), while having composition, density, and/or degree of magnetization distinct from the other particle types 710(a), 710(b), and 710(c).

As shown in FIG. 19, the 710(a) particles in the feed 708 are attracted to the magnet 706. No 710(a) type particles are shown downstream of the magnet 706. 710(b) and 710(c) type particles are not magnetic, passing over the magnet 706 and continue downstream in pipe 702. Particle type 710(b) has a lower density than particle type 710(c) as seen by their separation once the centrifugal forces have been applied in the bent pipe section 704, and the flow heads in a horizontal direction. The pipe 702 expands in a cone-like fashion downstream of the bent pipe section 704 at location 712. The expansion allows for easier physical segregation of the particle types 710(b) and 710(c) though, for example, slotted sections (not shown). Particles 710(a) can be recovered by stopping the feed, flushing the pipe 702 with liquid, reversing the magnetic flux on the magnet 706, and collecting the particles 710(a) that are no longer held by the magnetic force,

A listing of non-limiting embodiments is given below
1a. A method of separation based on inversion and/or lowering of the thermodynamic energy barrier by using one or more stressors applied at appropriate ratios to create lower energy points in the thermodynamic energy landscape, the method comprising using the one or more stressors to separate at least two reclaimable metals from a mixed-metal feed, wherein the one or more stressors is selected from the group consisting of
   a) a chemical stress, wherein the chemical stress is selected from the group consisting of an oxidant, an acid, a base, a ligand or chelate, a reactant, a speciating agent, a reducing agent, a nucleophile, and/or an electrophile;
   b) a mechanical stress, wherein the mechanical stress comprises principle stresses, deviatoric stresses, point forces, and/or body forces;
   c) a thermal stress;
   d) an electromagnetic radiation and/or light stress;
   e) an interfacial stress; and/or
   f) a magnetic flux gradient stress.
2a. The method of embodiment 1a, wherein the at least two reclaimable metals are selected from the group consisting of transition metals, other metals, and/or rare earth lanthanide metals; or wherein the at least two reclaimable metals are selected from the group consisting of iron, copper, silver, gold, nickel, palladium, tantalum, platinum, aluminum, zinc, tin, gallium, indium, scandium, yttrium, lanthanum, cerium, praseodymium, neodymium, promethium, samarium, europium, gadolinium, terbium, dysprosium, holmium, erbium, thulium, ytterbium, uranium, bismuth, and/or lutetium; or wherein the at least two reclaimable metals are selected from the group consisting of iron, tantalum, gallium, indium, praseodymium, neodymium, europium, and/or dysprosium.
3a. The method of any one of embodiments 1a or 2a, wherein at least one reclaimable metal of the at least two reclaimable metals is a rare earth lanthanide metal.
4a. The method of any one of embodiments 1a-3a,
wherein the at least two reclaimable metals comprise europium,
wherein the one or more stressors comprises the chemical stress,
wherein the method comprises
   i) adding water to the mixed-metal stream to extract the europium;
   ii) forming europium particles in the water; and
   iii) separating the europium particles from the remaining mixed-metal stream.
5a. The method of any one of embodiments 1a-4a,
wherein the at least two reclaimable metals comprise praseodymium,
wherein the one or more stressors comprise the chemical stress and the thermal stress,
wherein the method comprises
   i) adding water to the mixed-metal stream and heating to a temperature above 60° C. to extract the praseodymium;
   ii) forming praseodymium particles in the water; and
   iii) separating the praseodymium particles from the remaining mixed-metal stream.
6a. The method of embodiment 5a, wherein the water and the mixed-metal stream are heated to a temperature ranging from 60° C. to 150° C., or from 60° C. to 125° C., or from 60° C. to 100° C., or from 60° C. to 95° C., or from 80° C. to 150° C., or from 80° C. to 125° C., or from 80° C. to 100° C., or from 80° C. to 95° C.
7a. The method of any one of embodiments 1a-6a,
wherein the at least two reclaimable metals comprise neodymium,
wherein the one or more stressors comprises the chemical stress, mechanical stress, and/or the thermal stress,
wherein the method comprises
   i) combining a solvent and the mixed-metal stream and heating to a temperature ranging from 60° C. to 80° C. to extract the neodymium and/or applying the mechanical stress
   ii) forming neodymium particles in the water; and
   iii) separating the neodymium particles from the remaining mixed-metal stream, wherein the solvent comprises water and a base and has a pH ranging from 10 to 13.5.
8a. The method of any one of embodiments 1a-4a,
wherein the at least two reclaimable metals comprise praseodymium and neodymium, and the mixed-metal stream comprises at least one additional metal,
wherein the one or more stressors comprises the chemical stress, the mechanical stress, and/or the thermal stress,
wherein the method comprises
   i) adding water to the mixed-metal stream and heating to a temperature above 60° C. and applying the mechanical stress to extract the praseodymium and the neodymium and
   ii) forming praseodymium particles and neodymium particles in the water; and
   iii) separating the praseodymium particles and the neodymium particles from the remaining mixed-metal stream.
9a. The method of any one of embodiments 1a-8a,
wherein the at least two reclaimable metals comprise dysprosium and iron, and the mixed-metal stream comprises at least one additional metal,
wherein the one or more stressors comprising the chemical stress, the mechanical stress, and the thermal stress,
wherein the method comprises
   i) combining a solvent and the mixed-metal stream and heating to a temperature above 40° C. and/or applying the mechanical stress to extract the dysprosium and the iron and
   ii) forming dysprosium particles and iron particles in the solvent; and
   iii) separating the dysprosium particles and the iron particles from the remaining mixed-metal stream,
wherein the solvent comprises an acid and has a pH ranging from 2.5 to 4.0; or from 2.5 to 3.5; or from 3.0 to 4.0.
10a. The method of any one of embodiments 1a-9a,
wherein the at least two reclaimable metals comprise gallium and indium, and the mixed-metal stream comprises at least one additional metal,
wherein the one or more stressors comprises the chemical stress, the mechanical stress, and the thermal stress,
wherein the method comprises
   i) combining a solvent and the mixed-metal stream and heating to a temperature above 40° C. and/or applying the mechanical stress to extract the gallium and the indium;
   ii) forming gallium particles and indium particles in the solvent; and
   iii) separating the gallium particles and the indium particles from the remaining mixed-metal stream,
wherein the solvent comprises an acid and has a pH lower than 2.5.
11a. The method of any one of embodiments 1a-10a,
wherein the at least two reclaimable metals comprise tantalum, gold, platinum, and/or silver,
wherein the one or more stressors comprises electromagnetic radiation, light and/or thermal stress,
wherein the method comprises
   i) treating the mixed-metal steam in plasma;
   ii) separating out the tantalum, gold, and platinum and/or silver from the plasma; and
   iii) separating out the remaining mixed-metals from the plasma.
12a. The method of any one of embodiments 1a-3a,
wherein the at least two reclaimable metals comprise europium, praseodymium, neodymium, dysprosium, iron, and at least one additional metal,
wherein the one or more stressors comprise the chemical stress, the mechanical stress, and/or the thermal stress,
wherein the method comprises
   i) combining a solvent and the mixed-metal stream and heating to a temperature above 40° C. and applying the mechanical stress to extract the europium, the praseodymium, the neodymium, the dysprosium, and the iron,
   ii) forming europium particles, in the solvent; and
   iii) separating the europium particles, the praseodymium particles, the neodymium particles, the dysprosium particles, and the iron particles from the remaining mixed-metal stream,
wherein the solvent comprises an acid and has a pH ranging from 2.5-4, or from 2.5 to 3.5, or from 3.0 to 4.0.
13a. The method of any one of embodiments 1a-3a,
wherein the at least two reclaimable metals comprise praseodymium, neodymium, dysprosium, iron, and at least one additional metal,
wherein the one or more stressors comprises the chemical stress, the mechanical stress, and/or the thermal stress,
wherein the method comprises
   i) combining a solvent and the mixed-metal stream and heating to a temperature above 40° C. and applying the mechanical stress to extract the praseodymium, the neodymium, the dysprosium, and the iron,
   ii) forming praseodymium particles, neodymium particles, dysprosium particles, and iron particles in the solvent; and
   iii) separating the praseodymium particles, the neodymium particles, the dysprosium particles, and the iron particles from the remaining mixed-metal stream, wherein the solvent comprises an acid and has a pH ranging from 2.5-4, or from 2.5 to 3.5, or from 3.0 to 4.0.
14a. The method of any one of embodiments 1a-13a wherein at least two reclaimable metals are co-separated from the mixed-metal stream, forming a partially-separated metal stream, and wherein the method further comprises using the magnetic flux gradient stress to separate the at least two reclaimable metals in the partially-separated metal stream.
15a. The method of embodiment 14a, wherein the magnetic flux gradient is formed by a magnet placed proximate a curved pipe location at the largest degree of curvature and wherein the metals separate within the fluid base on differences in magnetic attraction and density.
16a. The method of any one of embodiments 1a-14a, wherein a first one of the one or more stressors is applied as a first asymmetric stress, and wherein the first asymmetric stress is selected from the group consisting of the chemical stress, the mechanical stress or the thermal stress.
17a. The method of embodiment 16a, wherein a second one of the one or more stressors is applied as a second asymmetric stress, and wherein the second asymmetric stress is selected from the group consisting of the chemical stress, the mechanical stress or the thermal stress; or wherein a second one of the one or more stressors is applied as a second asymmetric stress, and wherein the second asymmetric stress is selected from the group consisting of the chemical stress, the mechanical stress or the thermal stress, and wherein the first asymmetric stress and the second asymmetric stress are different.
18a. The method of embodiment 17a, wherein a first vector of the first asymmetric stress and a second vector of a second asymmetric stress are substantially opposed to one another; or wherein a first vector of the first asymmetric stress and a second vector of a second asymmetric stress are substantially uni-directional; or wherein a first vector of the first asymmetric stress and a second vector of the second asymmetric stress cross one another within the center 50 volume percent of a space, wherein the space defines the boundaries wherein the one or more stressors is applied to the mixed-metal feed.
1b. A process of separating a stream of electronic waste (e-waste) metals, wherein the e-waste metals comprise at least two reclaimable metals comprising a first reclaimable metal and a second reclaimable metal, the process comprising:
   a) performing a first extraction/precipitation/separation step of the e-waste metals to produce a productₓ and a (residual e-waste metals)ₓ, wherein x=1;
   b) performing a next extraction/precipitation/separation step of the (residual e-waste metals) to produce a productₓ₊₁ and a (residual e-waste metals)ₓ₊₁, and
   c) incrementing x by 1, and repeating step b) until an amount of the at least two reclaimable metals in the (residual e-waste metals)ₓ is less than 5 wt. %, or less than 2.5 wt. %, less than 1 wt. % or less than 0.5 wt. % of an amount of at least one of the at least two reclaimable metals in the e-waste metals,
wherein for each of the step a) and the step b) extractions/precipitation/separation steps, a variation is selected from the group consisting of a solvent, a solvent pH, an extraction temperature, an electromagnetic radiation stress, and/or a mechanical stress applied to the e-waste metals and/or (residual e-waste metals)ₓ.
2b. The process of embodiment 1b, wherein the product₁ comprises greater than 60 wt. % of the first reclaimable metal on a total metal basis, and the product₂ comprise greater than 60 wt. % of the second reclaimable metal on a total metal basis; or wherein the product₁ comprises the first reclaimable metal in a range of 60 wt. % to 100 wt. %, or 60 wt. % to 99.9 wt. %, or 60 wt. % to 99 wt. %, or 60 wt. % to 95 wt. %, or 60 wt. % to 90 wt. %, or 70 wt. % to 100 wt. %, or 70 wt. % to 99.9 wt. % or 60 wt. % to 99 wt. %, or 80 wt. % to 100 wt. %, or 80 wt. % to 99.9 wt. % or 80 wt. % to 99 wt. %, or 90 wt. % to 100 wt. %, or 90 wt. % to 99.9 wt. % or 60 wt. % to 99 wt. %, on a total metal basis and the product₂ comprises the second reclaimable metal in a range of 60 wt. % to 100 wt. %, or 60 wt. % to 99.9 wt. %, or 60 wt. % to 99 wt. %, or 60 wt. % to 95 wt. %, or 60 wt. % to 90 wt. %, or 70 wt. % to 100 wt. %, or 70 wt. % to 99.9 wt. % or 70 wt. % to 99 wt. %, or 80 wt. % to 100 wt. %, or 80 wt. % to 99.9 wt. %, or 80 wt. % to 99 wt. %, or 90 wt. % to 100 wt. %, or 90 wt. % to 99.9 wt. %, or 90 wt. % to 99 wt. % on a total metal basis.
3b. The process of any one of embodiments 1b or 2b, wherein the at least two reclaimable metals comprise europium, praseodymium, neodymium, dysprosium, gallium, indium, iron, and tantalum, wherein a) the first extraction/precipitation/separation step is performed with a solvent of water at a pH ranging from 6 to 8, and temperature ranging from 20° C. to 40° C., and wherein the (product) 1 comprises europium and (residual e-waste) 1 comprises praseodymium, neodymium, dysprosium, gallium, indium, iron, and tantalum.
4b. The process of embodiment 3b, wherein the step b) performing the next extraction/precipitation/separation step is performed on the (residual e-waste metals)₁ wherein the solvent is water at the pH ranging from 6 to 8, and the temperature ranges from 40° C. to 90° C., and wherein the (product)₂ comprises praseodymium and (residual e-waste)₂ comprises neodymium, dysprosium, gallium, indium, iron, and tantalum.
5b. The process of embodiment 4b, wherein the step b) performing the next extraction/precipitation/separation step is performed on the (residual e-waste metals)₂ wherein the solvent is water at the pH ranging from 10 to 13.5, the mechanical stress is applied, and the temperature ranges from 40° C. to 90° C., and wherein the (product)₃ comprises neodymium and (residual e-waste)₃ comprises dysprosium, gallium, indium, iron, and tantalum.
6b. The process of embodiment 5b, wherein the step b) performing the next extraction/precipitation/separation step is performed on the (residual e-waste metals)₃ wherein the solvent comprises acid at the pH ranging from 10 to 13.5, mechanical stress is applied, and the temperature ranges from 40° C. to 90° C., and wherein the (product)₄ comprises dysprosium and iron and (residual e-waste)₄ comprises gallium, indium, and tantalum.
7b. The process of embodiment 6b, wherein step b) performing the next extraction/precipitation/separation step is performed on the (residual e-waste metals)₄ wherein the solvent comprises an acid with a pH lower than 2.5, and the temperature ranges from 40° C. to 90° C., and wherein the (product) s comprises gallium and indium and (residual e-waste)₅ comprises tantalum.
8b. The process of embodiment 7b, further comprising adding the (residual e-waste)₅ to a plasma and optionally adding heat to produce a product comprising tantalum and (residual e-waste)₆.
9b. The process of any one of embodiments 6b-8b, wherein the process further comprises separating dysprosium and iron in (product)₄ and/or gallium and indium in (product) s using a curved pipe and applied magnetic force.
10b. The method of any one of embodiments 1b-9b, the extraction temperature selected requires the use of a thermal stress, wherein the thermal stress or the mechanical stress is applied as a first asymmetric stress.
11b. The method of embodiment 16a, wherein the thermal stress of the mechanical stress is applied as a second asymmetric stress, and wherein the second asymmetric stress is different from the first asymmetric stress.
12b. The method of embodiment 11b, wherein a first vector of the first asymmetric stress and a second vector of a second asymmetric stress are substantially opposed to one another; or wherein a first vector of the first asymmetric stress and a second vector of a second asymmetric stress are substantially uni-directional; or wherein a first vector of the first asymmetric stress and a second vector of the second asymmetric stress cross one another within the center 50 volume percent of a space, wherein the space defines the boundaries wherein the one or more stressors is applied to the e-waste metals and/or (residual e-waste metals)ₓ.
1c. A process of separating a stream of electronic waste (e-waste) metals, wherein the e-waste metals comprise europium, praseodymium, neodymium, dysprosium, gallium, indium, iron, and tantalum, and wherein by sequential extraction, varying a chemical stress, varying a mechanical stress, varying a thermal stress, varying an electromagnetic radiation and/or light stress, varying an interfacial stress, and/or varying a magnetic flux gradient stress, (alternatively, wherein by sequential extractions, varying a solvent, varying a pH of the solvent, and varying an extraction temperature, and/or varying a mechanical stress) applied to the e-waste metals and solvent for each of the sequential extractions to form a first residual metal and unrefined product streams, wherein
   a) a first set of the unrefined product streams comprises,
      1) a europium stream,
      2) a praseodymium stream,
      3) a neodymium stream,
      4) a dysprosium and iron stream, and
      5) a gallium and indium stream;
   b) a second set of the unrefined product streams comprises,
      1) a europium stream,
      2) a praseodymium and neodymium stream,
      3) a dysprosium and iron stream, and
      4) a gallium and indium stream;
   c) a third set of the unrefined product streams comprises,
      1) a europium stream,
      2) a praseodymium, neodymium dysprosium and iron stream, and
      3) a gallium and indium stream;
   d) a fourth set of the unrefined product streams comprises,
      1) a europium stream, and
      2) a praseodymium, neodymium, dysprosium, iron, gallium, and indium stream;
   e) a fifth set of the unrefined product streams comprises,
      1) a europium, praseodymium, neodymium, dysprosium, and iron stream, and
      2) a gallium and indium stream; or
   f) a sixth set of the unrefined product streams comprises,
      1) a europium, praseodymium, neodymium, dysprosium, iron, gallium, and indium stream;
2c. The process of embodiment 1c, further comprising applying the thermal stress and/or the electromagnetic radiation and/or light stress to the first residual metal to produce a tantalum stream and a second residual metal.
3c. The process of any one of embodiments 1c or 2c, further comprising separating out at least a portion of one of the metals from any of the unrefined product streams comprising two or more metals, wherein the separation comprises using a curved pipe and applied magnetic field.
4c. The process of any one of embodiments 1c-3c, further comprising analyzing the e-waste and using an algorithm to automatically determine which of the first, second, third, fourth, fifth, or sixth sets of unrefined product streams to produce.
5c. The process of any one of embodiments 1c-4c, wherein a feedback control based upon turbidity sensors and/or color sensors is used to optimize at least one of the sequential extractions.
1d. A method of purification based on inversion and/or lowering of the thermodynamic energy barrier by using one or more stressors applied at appropriate ratios to create lower energy points in the thermodynamic energy landscape, the method comprising
   1) using the one or more stressors on a mixed-metal feed to produce a mixed-metal residue and an intermediate product, wherein the intermediate product comprises target metal particles and at least one other metal particles, wherein the target metal particle comprise a higher weight percent of the target metal than in the mixed-metal feed; and
   2) producing a purified product, wherein the purified product comprises a higher weight percent of the target metal particle than the weight percent of the target metal particle in the intermediate product, by using the one or more stressors to separate the target metal particles from the at least one other metal particles by exploiting differences in at least one property, wherein the at least one property is selected from the group consisting of
      a) size;
      b) shape;
      c) density;
      d) magnetism; and/or
      e) solubility/extractability
wherein the one or more stressors is selected from the group consisting of
   i) a chemical stress, wherein the chemical stress is selected from the group consisting of an oxidant, an acid, a base, a ligand or chelate, a reactant, a speciating agent, a reducing agent, a nucleophile, and/or an electrophile;
   ii) a mechanical stress, wherein the mechanical stress comprises principle stresses, deviatoric stresses, point forces, and/or body forces;
   iii) a thermal stress;
   iv) an electromagnetic radiation and/or light stress;
   v) an interfacial stress; and/or
   vi) a magnetic flux gradient stress.

The types of metals and separation process steps and process conditions, and the asymmetric stressors in embodiment “a” apply as well to this embodiment “d.”
1e. A method of mixing based on inversion and/or lowering of the thermodynamic energy barrier by using one or more stressors applied at appropriate ratios to create lower energy points in the thermodynamic energy landscape, the method comprising using the one or more stressors to mix at least two metals into a mixed-metal product, wherein the one or more stressors is selected from the group consisting of
a) a chemical stress, wherein the chemical stress is selected from the group consisting of an oxidant, an acid, a base, a ligand or chelate, a reactant, a speciating agent, a reducing agent, a nucleophile, and/or an electrophile;
b) a mechanical stress, wherein the mechanical stress comprises principle stresses, deviatoric stresses, point forces, and/or body forces;
c) a thermal stress;
d) an electromagnetic radiation and/or light stress;
e) an interfacial stress; and/or
f) a magnetic flux gradient stress.
2e. The method of embodiment 1e, wherein the at least two metals are selected from the group consisting of transition metals, other metals, and/or rare earth lanthanide metals; or wherein the at least two metals are selected from the group consisting of iron, copper, silver, gold, nickel, palladium, tantalum, platinum, aluminum, zinc, tin, gallium, indium, scandium, yttrium, lanthanum, cerium, praseodymium, neodymium, promethium, samarium, europium, gadolinium, terbium, dysprosium, holmium, erbium, thulium, ytterbium, uranium, bismuth, and/or lutetium; or wherein the at least two metals are selected from the group consisting of iron, tantalum, gallium, indium, praseodymium, neodymium, europium, and/or dysprosium.
3e. The method of any one of embodiments 1e or 2e, wherein at least one metal of the at least two metals is a rare earth lanthanide metal.
4e. The method of any one of embodiments 1e-3e, wherein one of more stressors includes the chemical stress; or wherein the one of more stressors includes the chemical stress, wherein the chemical stress is selected from the group consisting of the acid and/or the base.
5e. The method of any one of embodiments 1e-4e, wherein the one or more stressors includes the mechanical stress.
6e. The method of any one of embodiments 1e-5e, wherein the one or more stressors includes the thermal stress.
7e. The method of any one of embodiments 1e-6e, wherein the one or more stressors includes the electromagnetic radiation and/or light stress.
8e. The method of any one of embodiments 1e-7e, wherein the one or more stressors includes the interfacial stress.
9e. The method of any one of embodiments 1e-8e, wherein the one or more stressors includes the magnetic flux stress.
10e. The method of any one of embodiments 1e-9e, wherein the mixed-metal product comprises a magnet.
1f. A method of separation based on inversion and/or lowering of the thermodynamic energy barrier by using one or more stressors applied at appropriate ratios to create lower energy points in the thermodynamic energy landscape, the method comprising using the one or more stressors to separate at least two reclaimable metals from a mixed-metal feed, wherein the one or more stressors is selected from the group consisting of
   a) a chemical stress, wherein the chemical stress is selected from the group consisting of an oxidant, an acid, a base, a ligand or chelate, a reactant, a speciating agent, a reducing agent, a nucleophile, and/or an electrophile;
   b) a mechanical stress, wherein the mechanical stress comprises principle stresses, deviatoric stresses, point forces, and/or body forces;
   c) a thermal stress;
   d) an electromagnetic radiation and/or light stress;
   e) an interfacial stress; and/or
   f) a magnetic flux gradient stress,
wherein one of the one or more stressors is a first asymmetric stress, and wherein the first asymmetric stress is selected from the group consisting of the chemical stress, the mechanical stress, or the thermal stress.
2f. The method of embodiment 1f, wherein one of the one or more stressors is applied as a second asymmetric stress, and wherein the second asymmetric stress is selected from the group consisting of the chemical stress, the mechanical stress, or the thermal stress; wherein one of the one or more stressors is applied as a second asymmetric stress, wherein the second asymmetric stress is selected from the group consisting of the chemical stress, the mechanical stress, or the thermal stress, and wherein the first asymmetric stress and the second asymmetric stress are different.
3f. The method of embodiment 2f, wherein a first vector of the first asymmetric stressor and a second vector of a second asymmetric stressor are substantially opposed to one another; or wherein a first vector of the first asymmetric stressor and a second vector of a second asymmetric stressor are substantially uni-directional; or wherein a first vector of the first asymmetric stressor and a second vector of the second asymmetric stressor cross one another within the center 50 volume percent of a space, wherein the space defines the boundaries wherein the one or more stressors is applied to the mixed-metal feed.
4f. The method of any one of embodiments 1f-3f, wherein the at least two reclaimable metals are selected from the group consisting of transition metals, other metals, and/or rare earth lanthanide metals; or wherein the at least two reclaimable metals are selected from the group consisting of iron, copper, silver, gold, nickel, palladium, tantalum, platinum, aluminum, zinc, tin, gallium, indium, scandium, yttrium, lanthanum, cerium, praseodymium, neodymium, promethium, samarium, europium, gadolinium, terbium, dysprosium, holmium, erbium, thulium, ytterbium, uranium, bismuth, and/or lutetium; or wherein the at least two reclaimable metals are selected from the group consisting of iron, tantalum, gallium, indium, praseodymium, neodymium, europium, and/or dysprosium.
5f. The method of any one of embodiments 1f-4f, wherein at least one reclaimable metal of the at least two reclaimable metals is a rare earth lanthanide metal.
6f. The method of any one of embodiments 1f-5f,
wherein the at least two reclaimable metals comprise europium,
wherein the one or more stressors comprises the chemical stress,
wherein the method comprises
   i) adding water to the mixed-metal stream to extract the europium;
   ii) forming europium particles in the water; and
   iii) separating the europium particles from the remaining mixed-metal stream.
7f. The method of any one of embodiments 1f-6f,
wherein the at least two reclaimable metals comprise praseodymium,
wherein the one or more stressors comprise the chemical stress and the thermal stress,
wherein the method comprises
   i) adding water to the mixed-metal stream and heating to a temperature above 60° C. to extract the praseodymium;
   ii) forming praseodymium particles in the water; and
   iii) separating the praseodymium particles from the remaining mixed-metal stream.
8f. The method of embodiment 7f, wherein the water and the mixed-metal stream are heated to a temperature ranging from 60° C. to 150° C., or from 60° C. to 125° C., or from 60° C. to 100° C., or from 60° C. to 95° C., or from 80° C. to 150° C., or from 80° C. to 125° C., or from 80° C. to 100° C., or from 80° C. to 95° C.
9f. The method of any one of embodiments 1f-8f,
wherein the at least two reclaimable metals comprise neodymium,
wherein the one or more stressors comprises the chemical stress, mechanical stress, and/or the thermal stress,
wherein the method comprises
   i) combining a solvent and the mixed-metal stream and heating to a temperature ranging from 60° C. to 80° C. to extract the neodymium and/or applying the mechanical stress
   ii) forming neodymium particles in the water; and
   iii) separating the neodymium particles from the remaining mixed-metal stream,
wherein the solvent comprises water and a base and has a pH ranging from 10 to 13.5.
10f. The method of any one of embodiments 1f-9f,
wherein the at least two reclaimable metals comprise praseodymium and neodymium, and the mixed-metal stream comprises at least one additional metal,
wherein the one or more stressors comprises the chemical stress, the mechanical stress, and/or the thermal stress,
wherein the method comprises
   i) adding water to the mixed-metal stream and heating to a temperature above 60° C. and applying the mechanical stress to extract the praseodymium and the neodymium and
   ii) forming praseodymium particles and neodymium particles in the water; and
   iii) separating the praseodymium particles and the neodymium particles from the remaining mixed-metal stream.
11f. The method of any one of embodiments 1f-10f,
wherein the at least two reclaimable metals comprise dysprosium and iron, and the mixed-metal stream comprises at least one additional metal,
wherein the one or more stressors comprising the chemical stress, the mechanical stress, and the thermal stress,
wherein the method comprises
   i) combining a solvent and the mixed-metal stream and heating to a temperature above 40° C. and/or applying the mechanical stress to extract the dysprosium and the iron and
   ii) forming dysprosium particles and iron particles in the solvent; and
   iii) separating the dysprosium particles and the iron particles from the remaining mixed-metal stream,
wherein the solvent comprises an acid and has a pH ranging from 2.5 to 4.0; or from 2.5 to 3.5; or from 3.0 to 4.0.
12f. The method of any one of embodiments 1f-11f,
wherein the at least two reclaimable metals comprise gallium and indium, and the mixed-metal stream comprises at least one additional metal,
wherein the one or more stressors comprises the chemical stress, the mechanical stress, and the thermal stress,
wherein the method comprises
   i) combining a solvent and the mixed-metal stream and heating to a temperature above 40° C. and/or applying the mechanical stress to extract the gallium and the indium;
   ii) forming gallium particles and indium particles in the solvent; and
   iii) separating the gallium particles and the indium particles from the remaining mixed-metal stream,
wherein the solvent comprises an acid and has a pH lower than 2.5.
13f. The method of any one of embodiments 1f-12f,
wherein the at least two reclaimable metals comprise tantalum, gold, platinum, and/or silver,
wherein the one or more stressors comprises electromagnetic radiation, light and/or thermal stress,
wherein the method comprises
   i) treating the mixed-metal steam in plasma;
   ii) separating out the tantalum, gold, and platinum and/or silver from the plasma; and
   iii) separating out the remaining mixed-metals from the plasma.
14f. The method of any one of embodiments 1f-5f,
wherein the at least two reclaimable metals comprise europium, praseodymium, neodymium, dysprosium, iron, and at least one additional metal,
wherein the one or more stressors comprise the chemical stress, the mechanical stress, and/or the thermal stress,
wherein the method comprises
   i) combining a solvent and the mixed-metal stream and heating to a temperature above 40° C. and applying the mechanical stress to extract the europium, the praseodymium, the neodymium, the dysprosium, and the iron,
   ii) forming europium particles, in the solvent; and
   iii) separating the europium particles, the praseodymium particles, the neodymium particles, the dysprosium particles, and the iron particles from the remaining mixed-metal stream,
wherein the solvent comprises an acid and has a pH ranging from 2.5-4, or from 2.5 to 3.5, or from 3.0 to 4.0.
15f. The method of any one of embodiments 1f-5f,
wherein the at least two reclaimable metals comprise praseodymium, neodymium, dysprosium, iron, and at least one additional metal,
wherein the one or more stressors comprises the chemical stress, the mechanical stress, and/or the thermal stress,
wherein the method comprises
   i) combining a solvent and the mixed-metal stream and heating to a temperature above 40° C. and applying the mechanical stress to extract the praseodymium, the neodymium, the dysprosium, and the iron,
   ii) forming praseodymium particles, neodymium particles, dysprosium particles, and iron particles in the solvent; and
   iii) separating the praseodymium particles, the neodymium particles, the dysprosium particles, and the iron particles from the remaining mixed-metal stream,
wherein the solvent comprises an acid and has a pH ranging from 2.5-4, or from 2.5 to 3.5, or from 3.0 to 4.0.
16f. The method of any one of embodiments 1f-15f wherein at least two reclaimable metals are co-separated from the mixed-metal stream, forming a partially-separated metal stream, and wherein the method further comprises using the magnetic flux gradient stress to separate the at least two reclaimable metals in the partially-separated metal stream.
17f. The method of embodiment 16f, wherein the magnetic flux gradient is formed by a magnet placed proximate a curved pipe location at the largest degree of curvature and wherein the metals separate within the fluid base on differences in magnetic attraction and density.
1g. A system for separation of a mixed-metal feed based on inversion and/or lowering of the thermodynamic energy barrier by using two or more stressors applied at appropriate ratios to create lower energy points in the thermodynamic energy landscape, the system comprising;
   a) a chamber capable of enclosing
      i) a solution comprising the mixed-metal feed; and
      ii) at least a first asymmetric stress and a second asymmetric stress, wherein the first asymmetric stress and the second asymmetric stress are selected from the group consisting of
         1) a chemical stress, wherein the chemical stress is selected from the group consisting of an oxidant, an acid, a base, a ligand or chelate, a reactant, a speciating agent, a reducing agent, a nucleophile, and/or an electrophile;
         2) a mechanical stress, wherein the mechanical stress comprises principle stresses, deviatoric stresses, point forces, and/or body forces; or
         3) a thermal stress;
   b) at least one closable opening into the chamber, wherein the at least one closable opening is capable of providing a pathway for the mixed-metal feed, the chemical stress and any separated metals to enter and leave the chamber;
   c) a variable temperature device capable of supplying the thermal stress; and
   d) mechanical device capable of supplying the mechanical stresses wherein a content of the chamber comprises the mixed-metal feed, any separated metals, and the solution, and wherein the thermal stress and the mechanical stress applied to the content of the chamber.
2g. The system of embodiment 1g, wherein when the variable temperature device receives a heated fluid from outside the chamber and the heated fluid heats the content of the chamber and exits the variable temperature device as a cooled fluid, wherein the system further comprises openings in the chamber for the heated fluid to enter and the cooled fluid to exit the chamber and a heat exchanger external to the chamber to heat the cooled fluid back to the heated fluid; or wherein when the variable temperature device receives a cooled fluid from outside the chamber and the cooled fluid cools the content of the chamber and exits the variable temperature device as a heated fluid, wherein the system further comprises openings in the chamber for the cooled fluid to enter and the heated fluid to exit the chamber and a heat exchanger external to the chamber to cool the heated fluid back to the cooled fluid.
3g. The system of any of embodiments 1g or 2g, the variable temperature device is located near a first section of a perimeter of the chamber.
4g. The system of any of embodiments 1g-3g, wherein the mechanical device comprises a rotor with attachments for applying the mechanical stress to the content of the chamber.
5g. The system of any of embodiments 1g-4g, wherein the mechanical device is located near a second section of the chamber.
6g. The system of any of the embodiments 1g-5g, wherein the first section of the perimeter of the chamber is located substantially across the chamber from the second section of the perimeter of the chamber.

The system embodiments “g” can be used to carry out all of the methods of embodiments “a”, “b”, “c”, “d”, “e”, and “f”.
1h. A system for separation of a mixed-metal feed based on inversion and/or lowering of the thermodynamic energy barrier by using two or more stressors applied at appropriate ratios to create lower energy points in the thermodynamic energy landscape, the system comprising:
   a) an extractor capable of containing a solution comprising the mixed-metal feed, wherein the extractor comprises a closeable hollow horizontal cylinder;
   b) a rotor placeable in the extractor with a proximal end outside of the extractor and a distal end with attachments within the extractor, wherein the rotor and attachments are capable of providing mechanical stress to the solution when the rotor turns;
   c) a motor connectable to the proximal end of a rotor, wherein the motor is capable of turning the rotor;
   d) a hole at the end of the extractor when the extractor is closed, through which the proximal end of the rotor transitions from outside the extractor to inside the extractor, wherein the hole is located below the midpoint of the cylinder;
   e) a rotor with a proximal end capable of fitting through the hole and a distal end with the attachments locatable within the extractor, wherein the rotor is capable of providing a mechanical stress to the solution when the rotor is turned; and
   f) a heat source in the top half of the extractor, wherein the heat source is capable of applying a thermal stress to the solution, wherein the system is capable of producing asymmetrical stresses on the solution.
2h. The system of embodiment 1h, further comprising a stator surrounding the rotor and the attachments, wherein the stator is a stationary hollow cylinder with rectangular slots along a length of the stator.
3h. The system of any one of embodiments 1h or 2h, wherein the extractor has a diameter between 5 inches and 5 feet and a length between 1 foot and 10 feet.
4h. The system of any one of embodiments 1h-3h, wherein a material of construction of the extractor is suitable for pH ranges from 1 to 13.
5h. The system of any one of embodiments 1h-4h, wherein the rotor extends at least 70%; at least 80%; at least 90%; at least 95%; or at least 98% of the length of the extractor.

The system embodiments “g” can be used to carry out all of the methods of embodiments “a”, “b”, “c”, “d”, “e”, and “f”.
1j. A process for separating rare-earth metals, the process comprising
   a) applying a magnetic force in a section of a curved pipe;
   b) feeding a first liquid stream comprising at least two mixed-rare-earth particles to the curved pipe, wherein the first mixed-rare-earth particles comprise a first rare-earth metal and the second mixed-rare-earth particles comprise a second rare-earth metal;
   c) stratifying the first mixed-rare-earth particle from the second mixed-earth particle along an inside diameter of the pipe; and
   d) collecting two separate outlet streams,
wherein the first outlet stream comprises a majority of the first mixed-rare-earth particles and the second outlet stream comprises a majority of the second mixed-rare-earth particles.
2j. The process of embodiment 1j, wherein the liquid is diamagnetic.
3j. The process of any one of embodiments 1j or 2j, wherein the magnetic force is applied to 360° of the outside pipe circumference, or to about 270° C., or to 180° C., or to 90° C.
4j. The process of any one of embodiments 1j-3j, wherein in step a) the magnetic force is applied to the section of the curved pipe with the largest degree of curvature.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A method of separation based on inversion and/or lowering of the thermodynamic energy barrier by using one or more stressors applied at appropriate ratios to create lower energy points in the thermodynamic energy landscape, the method comprising using the one or more stressors to separate at least two reclaimable metals from a mixed-metal feed, wherein the one or more stressors is selected from the group consisting of
a) a chemical stress, wherein the chemical stress is selected from the group consisting of an oxidant, an acid, a base, a ligand or chelate, a reactant, a speciating agent, a reducing agent, a nucleophile, and/or an electrophile;
b) a mechanical stress, wherein the mechanical stress comprises principle stresses, deviatoric stresses, point forces, and/or body forces;
c) a thermal stress;
d) an electromagnetic radiation and/or light stress;
e) an interfacial stress; and/or
f) a magnetic flux gradient stress.

2. The method of claim 1, wherein a first one of the one or more stressors is applied as a first asymmetric stress, and wherein the first asymmetric stress is selected from the group consisting of the chemical stress, the mechanical stress or the thermal stress.

3. The method of claim 2, wherein a second one of the one or more stressors is applied as a second asymmetric stress, and wherein the second asymmetric stress is selected from the group consisting of the chemical stress, the mechanical stress or the thermal stress.

4. The method of claim 3, wherein a first vector of the first asymmetric stress and a second vector of a second asymmetric stress are substantially opposed to one another.

5. The method of claim 1, wherein the at least two reclaimable metals are selected from the group consisting of transition metals, other metals, and/or rare earth lanthanide metals.

6. The method of claim 1, wherein at least one reclaimable metal of the at least two reclaimable metals is a rare earth lanthanide metal.

7. The method of claim 1,
wherein the at least two reclaimable metals comprise europium,
wherein the one or more stressors comprises the chemical stress,
wherein the method comprises
i) adding water to the mixed-metal stream to extract the europium;
ii) forming europium particles in the water; and
iii) separating the europium particles from the remaining mixed-metal stream.

8. The method of claim 1,
wherein the at least two reclaimable metals comprise praseodymium,
wherein the one or more stressors comprise the chemical stress and the thermal stress,
wherein the method comprises
i) adding water to the mixed-metal stream and heating to a temperature above 60° C. to extract the praseodymium;
ii) forming praseodymium particles in the water; and
iii) separating the praseodymium particles from the remaining mixed-metal stream.

9. The method of claim 8, wherein the water and the mixed-metal stream are heated to a temperature ranging from 60° C. to 150° C.

10. The method of claim 1,
wherein the at least two reclaimable metals comprise neodymium,
wherein the one or more stressors comprises the chemical stress, mechanical stress, and/or the thermal stress,
wherein the method comprises
i) combining a solvent and the mixed-metal stream and heating to a temperature ranging from 60° C. to 80° C. to extract the neodymium and/or applying the mechanical stress
ii) forming neodymium particles in the water; and
iii) separating the neodymium particles from the remaining mixed-metal stream,
wherein the solvent comprises water and a base and has a pH ranging from 10 to 13.5.

11. The method of claim 1,
wherein the at least two reclaimable metals comprise praseodymium and neodymium, and the mixed-metal stream comprises at least one additional metal,
wherein the one or more stressors comprises the chemical stress, the mechanical stress, and/or the thermal stress,
wherein the method comprises
i) adding water to the mixed-metal stream and heating to a temperature above 60° C. and applying the mechanical stress to extract the praseodymium and the neodymium and
ii) forming praseodymium particles and neodymium particles in the water; and
iii) separating the praseodymium particles and the neodymium particles from the remaining mixed-metal stream.

12. The method of claim 1,
wherein the at least two reclaimable metals comprise dysprosium and iron, and the mixed-metal stream comprises at least one additional metal,
wherein the one or more stressors comprising the chemical stress, the mechanical stress, and the thermal stress,
wherein the method comprises
i) combining a solvent and the mixed-metal stream and heating to a temperature above 40° C. and/or applying the mechanical stress to extract the dysprosium and the iron and
ii) forming dysprosium particles and iron particles in the solvent; and
iii) separating the dysprosium particles and the iron particles from the remaining mixed-metal stream,
wherein the solvent comprises an acid and has a pH ranging from 2.5 to 4.0.

13. The method of claim 1,
wherein the at least two reclaimable metals comprise gallium and indium, and the mixed-metal stream comprises at least one additional metal,
wherein the one or more stressors comprises the chemical stress, the mechanical stress, and the thermal stress,
wherein the method comprises
i) combining a solvent and the mixed-metal stream and heating to a temperature above 40° C. and/or applying the mechanical stress to extract the gallium and the indium;
ii) forming gallium particles and indium particles in the solvent; and
iii) separating the gallium particles and the indium particles from the remaining mixed-metal stream,
wherein the solvent comprises an acid and has a pH lower than 2.5.

14. The method of claim 1,
wherein the at least two reclaimable metals comprise tantalum, gold, platinum, and/or silver,
wherein the one or more stressors comprises electromagnetic radiation, light and/or thermal stress,
wherein the method comprises
i) treating the mixed-metal steam in plasma;
ii) separating out the tantalum, gold, platinum, and/or silver from the plasma; and
iii) separating out the remaining mixed-metals from the plasma.

15. The method of claim 1,
wherein the at least two reclaimable metals comprise europium, praseodymium, neodymium, dysprosium, iron, and at least one additional metal,
wherein the one or more stressors comprise the chemical stress, the mechanical stress, and/or the thermal stress,
wherein the method comprises
i) combining a solvent and the mixed-metal stream and heating to a temperature above 40° C. and applying the mechanical stress to extract the europium, the praseodymium, the neodymium, the dysprosium, and the iron,
ii) forming europium particles, in the solvent; and
iii) separating the europium particles, the praseodymium particles, the neodymium particles, the dysprosium particles, and the iron particles from the remaining mixed-metal stream,
wherein the solvent comprises an acid and has a pH ranging from 2.5-4.

16. The method of claim 1,
wherein the at least two reclaimable metals comprise praseodymium, neodymium, dysprosium, iron, and at least one additional metal,
wherein the one or more stressors comprises the chemical stress, the mechanical stress, and/or the thermal stress,
wherein the method comprises
i) combining a solvent and the mixed-metal stream and heating to a temperature above 40° C. and applying the mechanical stress to extract the praseodymium, the neodymium, the dysprosium, and the iron,
ii) forming praseodymium particles, neodymium particles, dysprosium particles, and iron particles in the solvent; and
iii) separating the praseodymium particles, the neodymium particles, the dysprosium particles, and the iron particles from the remaining mixed-metal stream, wherein the solvent comprises an acid and has a pH ranging from 2.5-4.

17. The method of claim 1 wherein at least two reclaimable metals are co-separated from the mixed-metal stream, forming a partially-separated metal stream, and wherein the method further comprises using the magnetic flux gradient stress to separate the at least two reclaimable metals in the partially-separated metal stream.

18. The method of claim 17, wherein the magnetic flux gradient is formed by a magnet placed proximate a curved pipe location at the largest degree of curvature and wherein the metals separate within the fluid base on differences in magnetic attraction and density.

19. A method of separation based on inversion and/or lowering of the thermodynamic energy barrier by using one or more stressors applied at appropriate ratios to create lower energy points in the thermodynamic energy landscape, the method comprising using the one or more stressors to separate at least two reclaimable metals from a mixed-metal feed, wherein the one or more stressors is selected from the group consisting of
a) a chemical stress, wherein the chemical stress is selected from the group consisting of an oxidant, an acid, a base, a ligand or chelate, a reactant, a speciating agent, a reducing agent, a nucleophile, and/or an electrophile;
b) a mechanical stress, wherein the mechanical stress comprises principle stresses, deviatoric stresses, point forces, and/or body forces;
c) a thermal stress;
d) an electromagnetic radiation and/or light stress;
e) an interfacial stress; and/or
f) a magnetic flux gradient stress,
wherein one of the one or more stressors is a first asymmetric stress, and wherein the first asymmetric stress is selected from the group consisting of the chemical stress, the mechanical stress, or the thermal stress.

20. The method of claim 19, wherein one of the one or more stressors is applied as a second asymmetric stress, and wherein the second stress is selected from the group consisting of the chemical stress, the mechanical stress, or the thermal stress.

21. The method of claim 20, wherein a first vector of the first asymmetric stressor and a second vector of a second asymmetric stressor are substantially opposed to one another.

22. The method of claim 19, wherein the at least two reclaimable metals are selected from the group consisting of transition metals, other metals, and/or rare earth lanthanide metals.

23. The method of claim 19, wherein at least one reclaimable metal of the at least two reclaimable metals is a rare earth lanthanide metal.

24. A process of separating a stream of electronic waste (e-waste) metals, wherein the e-waste metals comprise at least two reclaimable metals comprising a first reclaimable metal and a second reclaimable metal, the process comprising:
a) performing a first extraction/precipitation/separation step of the e-waste metals to produce a product, and a (residual e-waste metals)ₓ, wherein x=1;
b) performing a next extraction/precipitation/separation step of the (residual e-waste metals)ₓ to produce a productₓ₊₁ and a (residual e-waste metals)ₓ₊₁, and
c) incrementing x by 1, and repeating step b) until an amount of the at least two reclaimable metals in the (residual e-waste metals)ₓ is less than 5 wt. % of an amount of at least one of the at least two reclaimable metals in the e-waste metals,
wherein for each of the step a) and the step b) extractions/precipitation/separation steps, a variation is selected from the group consisting of a solvent, a solvent pH, an extraction temperature, an electromagnetic radiation stress, and/or a mechanical stress applied to the e-waste metals and/or (residual e-waste metals)ₓ.

25. The process of claim 24, wherein the product₁ comprises greater than 60 wt. % of the first reclaimable metal on a total metal basis, and the product₂ comprise greater than 60 wt. % of the second reclaimable metal on a total metal basis.

26. The process of claim 25, wherein the at least two reclaimable metals comprise europium, praseodymium, neodymium, dysprosium, gallium, indium, iron, and tantalum, wherein a) the first extraction/precipitation/separation step is performed with a solvent of water at a pH ranging from 6 to 8, and temperature ranging from 20° C. to 40° C., and wherein the (product)₁ comprises europium and (residual e-waste)₁ comprises praseodymium, neodymium, dysprosium, gallium, indium, iron, and tantalum.

27. The process of claim 26, wherein the step b) performing the next extraction/precipitation/separation step is performed on the (residual e-waste metals)₁ wherein the solvent is water at the pH ranging from 6 to 8, and the temperature ranges from 40° C. to 90° C., and wherein the (product)₂ comprises praseodymium and (residual e-waste)₂ comprises neodymium, dysprosium, gallium, indium, iron, and tantalum.

28. The process of claim 27, wherein the step b) performing the next extraction/precipitation/separation step is performed on the (residual e-waste metals)₂ wherein the solvent is water at the pH ranging from 10 to 13.5, the mechanical stress is applied, and the temperature ranges from 40° C. to 90° C., and wherein the (product)₃ comprises neodymium and (residual e-waste)₃ comprises dysprosium, gallium, indium, iron, and tantalum.

29. The process of claim 28, wherein the step b) performing the next extraction/precipitation/separation step is performed on the (residual e-waste metals)₃ wherein the solvent comprises acid at the pH ranging from 10 to 13.5, mechanical stress is applied, and the temperature ranges from 40° C. to 90° C., and wherein the (product)₄ comprises dysprosium and iron and (residual e-waste)₄ comprises gallium, indium, and tantalum.

30. The process of claim 29, wherein step b) performing the next extraction/precipitation/separation step is performed on the (residual e-waste metals)₄ wherein the solvent comprises an acid with a pH lower than 2.5, and the temperature ranges from 40° C. to 90° C., and wherein the (product)₅ comprises gallium and indium and (residual e-waste) s comprises tantalum.

31. The process of claim 31, further comprising adding the (residual e-waste)₅ to a plasma and optionally adding heat to produce a product comprising tantalum and (residual e-waste)₆.

32. A system for separation of a mixed-metal feed based on inversion and/or lowering of the thermodynamic energy barrier by using two or more stressors applied at appropriate ratios to create lower energy points in the thermodynamic energy landscape, the system comprising;
a) a chamber capable of enclosing
i) a solution comprising the mixed-metal feed;
ii) at least a first asymmetric stress and a second asymmetric stress, wherein the first asymmetric stress and the second asymmetric stress are selected from the group consisting of
1) a chemical stress, wherein the chemical stress is selected from the group consisting of an oxidant, an acid, a base, a ligand or chelate, a reactant, a speciating agent, a reducing agent, a nucleophile, and/or an electrophile;
2) a mechanical stress, wherein the mechanical stress comprises principle stresses, deviatoric stresses, point forces, and/or body forces; or
3) a thermal stress;
b) at least one closable opening through the chamber, wherein the closable opening is capable of providing a pathway for the mixed-metal feed, the chemical stress and any separated metals to enter and leave the chamber;
c) a variable temperature device capable of supplying the thermal stress; and
d) mechanical device capable of supplying the mechanical stresses
wherein a content of the chamber comprises the mixed-metal feed, any separated metals, and the solution, and wherein the thermal stress and the mechanical stress applied to the content of the chamber.

33. A system for separation of a mixed-metal feed based on inversion and/or lowering of the thermodynamic energy barrier by using two or more stressors applied at appropriate ratios to create lower energy points in the thermodynamic energy landscape, the system comprising:
a) an extractor capable of containing a solution comprising the mixed-metal feed, wherein the extractor comprises a closeable hollow horizontal cylinder;
b) a rotor placeable in the extractor with a proximal end outside of the extractor and a distal end with attachments within the extractor, wherein the rotor and attachments are capable of providing mechanical stress to the solution when the rotor turns;
c) a motor connectable to the proximal end of a rotor, wherein the motor is capable of turning the rotor;
d) a hole at the end of the cylinder when the extractor is closed, through which the proximal end of the rotor transitions from outside the extractor to insiFIG.de the extractor, wherein the hole is located below the midpoint of the cylinder and wherein the proximal end of the rotor is capable of fitting through the hole;
e) a heat source in the top half of the extractor, wherein the heat source is capable of applying a thermal stress to the solution,
wherein the system is capable of producing asymmetrical stresses on the solution.
